(19) United States
(12) Patent Application Publication
(10) Pub. No.: US 2023/0294609 A1
(43) Pub. Date: Sep. 21, 2023

(54) Improvements in or relating to support frames for vehicles

(71) Applicant: Robert Brian Hall, Grimsay (GB)

(72) Inventor: Robert Brian Hall, Grimsay (GB)

(73) Assignee: Studio Vans Ltd, Grimsay (GB)

(21) Appl. No.: 18/017,032

(22) PCT Filed: Jul. 21, 2021
(86) PCT No.: PCT/GB2021/051886

§ 371 Date: Jan. 19, 2023

(30) Foreign Application Priority Data
Jul. 22, 2020 (GB) 2011369.2

(51) Int. Cl. B60R 5/00

(52) U.S. Cl. CPC B60R 5/003

(57) ABSTRACT

A modular support frame for a vehicle comprising at least two frame modules, wherein the at least two frame modules are configured to be attachable to one another at more than one location.

### FIELD OF THE INVENTION

The present invention relates to a support frame for a vehicle, particularly, but not exclusively, a modular support frame for a vehicle and a method of installing the same in a vehicle.

### BACKGROUND TO THE INVENTION

Support frames for supporting appliances and amenities, such as domestic appliances and retail appliances, for vehicles are known.

Such support frames are typically installed when a vehicle is being converted for another purpose. This may be when a van is converted to a campervan, or the like.

While such known support frames are capable of supporting various appliances and amenities in vehicles, their function is limited.

Known support frames are typically configured to be bespoke to the vehicle to which they are mounted. That is, a support frame is created for a particular vehicle with a particular layout and arrangement of features being fixed. Furthermore, because of the way that known support frames are mounted to vehicles, they occupy a significant amount of floor space, which reduces load carrying capacity of the vehicle and is not aesthetically pleasing.

The inventor has appreciated the shortcomings in known support frames for vehicles and methods of installing the same.

### STATEMENTS OF INVENTION

According to a first aspect of the present invention there is provided a modular support frame for a vehicle comprising:
at least two frame modules,
wherein the at least two frame modules are configured to be attachable to one another at more than one location.

The term vehicle relates to a machine capable of transporting people or cargo. The vehicle may be a car, van, boat, ship, train, truck, lorry, mobile plant, emergency vehicle, campervan, motorhome, aircraft, or the like.

The vehicle may have a base portion. The vehicle may have a floor portion. The base portion, or floor portion, may be a load carrying area. The base portion, or floor portion, may include a load carrying area. The base portion or floor portion may be a load space. The base portion or floor portion may include a load space. The load carrying area, or load space, may be capable of receiving a load. The load carrying area, or load space, may be substantially rectangular. The load carrying area, or load space, may be generally rectangular in shape. The load carrying area, or load space, may be located generally between the front, rear and sides of the vehicle. The load carrying area, or load space, may be located generally between the front, rear and the wheel arches on the sides of the vehicle.

The vehicle may include one or more side portions. The side portions may be wall members. The side portions, or wall members, may be side walls. The vehicle may include two side portions. The side portions may be oppositely facing. The side portions may be located on the side of the vehicle. The side portions may extend between the rear of the vehicle and the front of the vehicle.

The vehicle may include a front portion. The front portion may be located behind the driving cab of the vehicle. The front portion may include a wall member. Alternatively, the front portion may be open, or at least partially open. In this arrangement the front portion defines an end portion of the load carrying area adjacent to the driving cab of the vehicle.

The vehicle may include one or more doors. The one or more doors may be located at the rear of the vehicle. The one or more doors may be rear doors. The one or more doors may be configured to allow access to the rear of the vehicle. The one or more doors may be configured to allow access to the load carrying area/space of the vehicle. The vehicle may include one or more side doors. The one or more side doors may be configured to allow access to the load carrying area/space of the vehicle.

The vehicle may include a roof portion. Together, the roof portion, the base portion, the two side portions, the front portion and the rear portion define an internal volume of the vehicle. The internal volume of the vehicle may be a load carrying volume. The internal environment may have an area and volume capable of storing cargo or transporting people. The internal environment may have a load carrying area, that is an area of space capable of receiving a load.

The roof portion may be supported by at least the side portions and rear portion of the vehicle.

The vehicle may have a longitudinal axis. The longitudinal axis may extend between the front and rear of the vehicle. The vehicle may have a lateral axis. The lateral axis may extend between each side of the vehicle. The vehicle may have a vertical axis. The vertical axis may be perpendicular to the longitudinal axis and the lateral axis. The three axes may be orthogonally arranged.

The base portion may have a longitudinal axis. The longitudinal axis may extend between the front and rear of the vehicle. The base portion may have a lateral axis. The lateral axis may extend between each side of the base portion.

The area of the load carrying space, or floor load carrying space, of the vehicle may be smaller than the area of the base portion of the vehicle. The load carrying area of the vehicle may be located within the area of the base portion of the vehicle.

The vehicle may include at least one area, or space, between a side portion of the vehicle and the load carrying area of the vehicle. The at least one area may be generally rectangular. However, it will be appreciated that the at least one area may be a different shape depending on the vehicle and load carrying area thereof. The at least one area may extend between the rear portion of the vehicle and the front portion of the vehicle.

The vehicle may include an area, or space, between each side portion of the vehicle and the load carrying area of the vehicle. Each area may be generally rectangular. Each area may extend between the rear portion of the vehicle and the front portion of the vehicle. Each area may be separated by the load carrying area of the vehicle.

The vehicle may include an area, or space, between the front portion of the vehicle and the load carrying area of the vehicle. The area may be generally rectangular.

The vehicle may include an area, or space, between the rear portion of the vehicle and the load carrying area of the vehicle. The area may be generally rectangular.

The vehicle may include an area, or space, between each side portion of the vehicle and the load carrying area of the vehicle, and an area, or space, between the front portion of the vehicle and the load carrying area of the vehicle. The areas may be generally rectangular.

The vehicle may include an area, or space, between each side portion of the vehicle and the load carrying area of the vehicle, and an area, or space, between the rear portion of the vehicle and the load carrying area of the vehicle. The areas may be generally rectangular.

The vehicle may include an area, or space, between each side portion of the vehicle and the load carrying area of the vehicle, an area, or space, between the front portion of the vehicle and the load carrying area of the vehicle, and an area, or space, between the rear portion of the vehicle and the load carrying area of the vehicle. The areas may be generally rectangular. In this arrangement the areas between each portion of the vehicle and the load carrying area of the vehicle create a perimeter around the load carrying area of the vehicle.

The areas, or spaces, between each portion of the vehicle and the load carrying area of the vehicle may include one or more attachment points. The one or more attachment points may be support frame attachment points. The one or more attachment points may be configured to receive and engage with the modular support frame.

The vehicle may include one or more attachment points. The attachment points may be configured to allow one or more objects, or articles, to be attached thereto. The one or more attachment points may be capable of releasably attaching one or more objects, or articles, to be attached thereto. The one or more attachment points may be capable of receiving a tethering member. The one or more attachment points may be capable of securing cargo within the vehicle. The one or more attachment points may be capable of anchoring cargo to a location within the vehicle. The one or more attachment points may provide a means of prohibiting movement of cargo relative to the vehicle during transit. The one or more attachment points may be anchoring points, or article/object attachment points. The attachment points may be cargo tie-down points. The attachment points may be pre-existing or retrofitted within the vehicle.

The one or more attachment points may be configured to provide support to an article, or object, attached thereto.

The one or more attachment points may be configured to receive a threaded member. The one or more attachment points may be configured to receive a threaded screw member, bolt member, or the like. The one or more attachment points may be D-rings, pins, slots, hinges, cups, threaded holes/bores, or threaded rods, or the like.

The one or more attachment points may comprise a bracket, a pin, a slot, a hinge, a cup, a threaded hole, a threaded rod, or the like.

The one or more attachment points may be support frame attachment points. The one or more attachment points may be configured to receive and engage with the modular support frame.

The one or more attachment points may be located on the base portion of the vehicle. The one or more attachment points may be located on the load carrying area of the vehicle. The one or more attachment points may be located outside the load carrying area of the vehicle. The one or more attachment points may be located in an area, or space, between a side portion of the vehicle and the load carrying area of the vehicle. The one or more attachment points may be located in an area, or space, between each side portion of the vehicle and the load carrying area of the vehicle. The one or more attachment points may be located in an area, or space, between the front portion of the vehicle and the load carrying area of the vehicle. The one or more attachment points may be located in an area, or space, between the rear portion of

The one or more attachment points may be located in an area, or space, between each side portion of the vehicle and the load carrying area of the vehicle, and an area, or space, between the front portion of the vehicle and the load carrying area of the vehicle.

The one or more attachment points may be located in an area, or space, between each side portion of the vehicle and the load carrying area of the vehicle, and an area, or space, between the rear portion of the vehicle and the load carrying area of the vehicle.

The one or more attachment points may be located in an area, or space, between each side portion of the vehicle and the load carrying area of the vehicle, an area, or space, between the front portion of the vehicle and the load carrying area of the vehicle, and an area, or space, between the rear portion of the vehicle and the load carrying area of the vehicle. In this arrangement the attachment points create a perimeter around the load carrying area of the vehicle.

The one or more attachment points may be located on at least one of the side portions/wall members of the vehicle. The one or more attachment points may be located on each side portion/wall member of the vehicle.

The one or more attachment points may be located on at least one of the side portions/wall members of the vehicle and the front portion of the vehicle.

The one or more attachment points may be located on at least one of the side portions/wall members of the vehicle and the rear portion of the vehicle.

The one or more attachment points may be located on at least one of the side portions/wall members of the vehicle, the front portion of the vehicle, and the rear portion of the vehicle.

The one or more attachment points may be arranged to lie on a plane. The one or more attachment points may be arranged to lie on two planes. The one or more attachment points may be arranged to lie on the same plane. The one or more attachment points may be arranged to lie on two different planes. The one or more attachment points may be arranged to be the same height from the base portion of the vehicle. Alternatively, the one or more attachment points may be arranged to lie on different planes. Alternatively, the one or more attachment points may be arranged to be at different heights from the base portion of the vehicle.

The attachment points may be located outside the load carrying area of the vehicle. In this arrangement the attachment points create a perimeter around the load carrying area of the vehicle.

Each attachment point may be associated with a lower support attachment point. The lower support attachment point may be attached to the side portions/wall members of the vehicle. Between each attachment point and the lower support attachment point there may be provide a support member, such as a strut member or brace member. The lower support attachment point and support member may provide additional support to the side portions/wall members of the vehicle to support the modular support frame.

The vehicle may include one or more attachment points on the base portion of the vehicle and the side portions/wall members of the vehicle.

The modular support frame may have a longitudinal axis. The longitudinal axis may extend between a front portion and rear portion of the frame. The modular support frame may have a lateral axis. The lateral axis may extend between each side of the frame. The modular support frame may have a vertical axis. The vertical axis may be perpendicular to the longitudinal axis and the lateral axis. The three axes may be orthogonally arranged.

The modular support frame may be a structural support member. The modular support frame may be constructed of a plurality of structural members. The plurality of structural members may be arranged to construct the support frame.

Each structural support member may be an elongate frame member. The structural support members may be fixedly attachable to one another to form the support frame. The structural support members may be releasably attachable to one another to form the support frame. The plurality of structural members may be fixedly attached by welding, gluing, bolting, or riveting, or the like, to construct the support frame.

Each frame module of the modular support frame may be a structural support member. Each frame module may be constructed of a plurality of structural members. The plurality of structural members may be arranged to construct the frame module.

The structural support members may be fixedly attachable to one another to form the frame module. The structural support members may be releasably attachable to one another to form the frame module. The plurality of structural members may be fixedly attached by welding, gluing, bolting, or riveting, or the like, to construct the frame module.

The modular support frame may be made from metal, aluminium, metal alloy, fibre composites (e.g., glass fibre, carbon fibre etc.), plastic, recycled plastic, timber, laminated timber, ceramics, or the like.

The structural support members may be made from metal, aluminium, metal alloy, fibre composites (e.g., glass fibre, carbon fibre etc.), plastic, recycled plastic, timber, laminated timber, ceramics, or the like.

The modular support frame may be configured such that it may be installed in the vehicle. The modular support frame may be installed in the vehicle such that its longitudinal axis is substantially parallel to the longitudinal axis of the vehicle. The modular support frame may be installed in the vehicle such that its lateral axis is substantially parallel to the lateral axis of the vehicle. The modular support frame may be installed in the vehicle such that its vertical axis is substantially parallel to the vertical axis of the vehicle.

The modular support frame may be configured such that it is attachable to the vehicle. The modular support frame may be configured such that it is releasably attachable to the vehicle. The modular support frame may be fixedly attachable to the vehicle. The modular support frame may be fixedly attached to the vehicle. The modular support frame may be fixedly attached to the vehicle by welding, gluing, bolting, riveting, or the like.

The modular support frame may be fixed to the vehicle. The modular support frame may be installed in the vehicle in such a manner that it may be removed from the vehicle. The modular support frame may be removably attachable to the vehicle.

The modular support frame may be attached to the vehicle by an adhesive. The modular support frame may be attached to the vehicle by magnetic force.

The modular support frame may be attachable to the base portion/floor portion of the vehicle. The modular support frame may be attachable to the load carrying area of the vehicle.

The modular support frame may be attachable to the least one area, or space, between the side portion of the vehicle and the load carrying area of the vehicle. The modular support frame may be attachable to each area, or space, between the side portion of the vehicle and the load carrying area of the vehicle. The modular support frame may be attachable to the least one area, or space, between the front portion of the vehicle and the load carrying area of the vehicle. The modular support frame may be attachable to the least one area, or space, between the rear portion of the vehicle and the load carrying area of the vehicle. The modular support frame may be attachable to the least one carrying area of the vehicle, the area, or space, between the front portion of the vehicle and the load carrying area of the vehicle, and the area, or space, between the rear portion of the vehicle and the load carrying area of the vehicle.

The modular support frame may be attachable to the vehicle such that it is spaced from the base portion of the vehicle. In this arrangement the modular support frame may be spaced from the load carrying area of the vehicle. That is, the modular support frame may be raised from the base portion/load carrying area of the vehicle. In this arrangement the load carrying area of the vehicle is accessible, as the modular support frame is located above the load carrying area.

The modular support frame may be substantially parallel to the base portion/load carrying area of the vehicle.

The raised modular support frame may allow for additional storage within the vehicle underneath the modular support frame. The raised modular support frame may allow for the installation of a further floor, or base portion, in the vehicle. The raised modular support frame may allow for the installation of an underfloor heating module within the vehicle. The raised modular support frame may allow for an increased volume of air above an underfloor heating module so as to improve the flow of hot air within the vehicle. The raised modular support frame may allow for enhanced aesthetic qualities of the interior of the vehicle. The raised modular support frame may improve the aesthetic appearance of the interior of the vehicle. The raised modular support frame may improve the aesthetic quality of the interior of the vehicle. The raised modular support frame may create the impression of an increased space and/or volume within the vehicle. The raised modular support frame may create the visible impression of an increased space and/or volume within the vehicle.

The modular support frame may be attachable to the one or more side portions of the vehicle. The modular support frame may be attachable to the side portions/wall members of the vehicle. The modular support frame may be attachable to each side portion/wall member of the vehicle. The modular support frame may be attachable to oppositely facing side portions/wall members of the vehicle.

In this arrangement the modular support frame may be spaced from the base portion of the vehicle. In this arrangement the modular support frame may be spaced from the load carrying area of the vehicle. That is, the modular support frame may be raised from the base portion of the vehicle. In this arrangement the load carrying area of the vehicle is accessible, as the modular support frame is located above the load carrying area.

The modular support frame may be attachable to the one or more attachment points of the vehicle. The modular support frame may be attachable to the one or more support frame attachment points of the vehicle.

The modular support frame may include one or more vehicle attachment members. The one or more vehicle attachment members may be configured to engage with the one or more attachment points/support frame attachment points of the vehicle.

The modular support frame may have a front portion, a rear portion and two side portions.

The one or more vehicle attachment members may be located on the front portion, rear portion, or side portions of the modular support frame. The one or more vehicle attachment members may be located on the at least one, or each, side portion of the modular support frame. The vehicle attachment members may be located on the perimeter of the modular support frame. The vehicle attachment members may be located on the outer edges of the modular support frame.

The one or more vehicle attachment members may be located on a lower surface of the modular support frame.

The modular support frame may be attachable to the vehicle such that it is located substantially on the base portion of the vehicle. The modular support frame may be attachable to the vehicle such that it is located substantially on the load carrying area of the vehicle.

The modular support frame may include one or more support legs, or leg members. The modular support frame may include a plurality of support legs, or leg members. The one or more support legs, or leg members, may be configured to provide support to the modular support frame. The one or more support legs, or leg members, may be configured to provide support to the modular support frame when the modular support frame is attached to the base portion of the vehicle.

The one or more support legs, or leg members, may be located on the lower surface of the modular support frame. The one or more support legs, or leg members, may be located on the front portion, rear portion, or side portions of the modular support frame. The one or more support legs, or leg members, may be located on at least one, or each, side portion of the modular support frame. The support legs, or leg members, may be located on the perimeter of the modular support frame. The support legs, or leg members, may be located on the outer edges of the modular support frame.

The one or more vehicle attachment members may be located on the support legs/leg members. The one or more vehicle attachment members may be located on the lower portion of the support legs/leg members.

The vehicle attachment members of the support legs/leg members may be configured to engage with the support frame attachment points of the vehicle. In this arrangement the modular support frame may be spaced from the load carrying area of the vehicle. That is, the modular support frame may be raised from the base portion of the vehicle. In this arrangement the load carrying area of the vehicle is accessible, as the modular support frame is located above the load carrying area.

Where the vehicle attachment members of the modular support frame are attached to the frame attachment points on the side portions/wall members of the vehicle, the modular support frame may be spaced from the load carrying area of the vehicle. That is, the modular support frame may be raised from the base portion of the vehicle. In this arrangement the load carrying area of the vehicle is accessible, as the modular support frame is located above the load carrying area.

The vehicle attachment members may include releasable fastening devices. The vehicle attachment members may include mechanical fastening devices. The vehicle attachment members may include a nut and bolt fastening device, or the like.

The vehicle attachment members may be arranged to correspond to the frame attachment points of the vehicle. The location of the vehicle attachment members on the modular support frame may be arranged to align with the location of the one or more attachment points on the vehicle.

Each frame module of the modular support frame may be attachable separately to the vehicle. Each frame module of the modular support frame may be attachable independently to the vehicle. Alternatively, the frame modules may be attached together to form the modular support frame and then the modular support frame is attached to the vehicle.

Each frame module of the modular support frame may be configured such that it is attachable to the vehicle. Each frame module may be configured such that it is releasably attachable to the vehicle. Each frame module may be fixedly attachable to the vehicle. Each frame module may be fixedly attached to the vehicle. Each frame module may be fixedly attached to the vehicle by welding, gluing, bolting, riveting, or the like.

Each frame module of the modular support frame may be fixed to the vehicle. Each frame module of the modular support frame may be installed in the vehicle in such a manner that it may be removed from the vehicle. Each frame module of the modular support frame may be removably attachable to the vehicle.

Each frame module may be attached to the vehicle by an adhesive. Each frame module may be attached to the vehicle by magnetic force.

Each frame module may be attachable to the base portion/floor portion of the vehicle. Each frame module may be attachable to the load carrying area of the vehicle.

Each frame module may be attachable to the least one area, or space, between the side portion of the vehicle and the load carrying area of the vehicle. Each frame module may be attachable to each area, or space, between the side portion of the vehicle and the load carrying area of the vehicle. Each frame module may be attachable to the least one area, or space, between the front portion of the vehicle and the load carrying area of the vehicle. Each frame module may be attachable to the least one area, or space, between the rear portion of the vehicle and the load carrying area of the vehicle. Each frame module may be attachable to the least one area, or space, between each side portion of the vehicle and the load carrying area of the vehicle, the area, or space, between the front portion of the vehicle and the load carrying area of the vehicle, and the area, or space, between the rear portion of the vehicle and the load carrying area of the vehicle.

Each frame module may be attachable to the vehicle such that it is spaced from the base portion of the vehicle. In this arrangement the frame modules may be spaced from the load carrying area of the vehicle. That is, the frame modules may be raised from the base portion of the vehicle. In this arrangement the load carrying area of the vehicle is accessible, as the frame modules are located above the load carrying area.

Each frame module may be attachable to the one or more side portions of the vehicle. Each frame module may be attachable to the wall members of the vehicle. Each frame module may be attachable to each side portion/wall member of the vehicle. Each frame module may be attachable to oppositely facing side portions/wall members of the vehicle.

In this arrangement the frame modules may be spaced from the base portion of the vehicle. In this arrangement the frame modules may be spaced from the load carrying area of the vehicle. That is, the frame modules may be raised from the base portion of the vehicle. In this arrangement the load carrying area of the vehicle is accessible, as the frame modules are located above the load carrying area.

Each frame module may be attachable to the one or more attachment points of the vehicle. Each frame module may be attachable to the one or more support frame attachment points of the vehicle.

Each frame module may include one or more vehicle attachment members. The one or more vehicle attachment members may be configured to engage with the one or more attachment points/support frame attachment points of the vehicle.

Each frame module may have a front portion, a rear portion, two side portions, an upper portion and a lower portion.

The one or more vehicle attachment members may be located on the front portion, rear portion, or side portions of the frame module. The one or more vehicle attachment members may be located on the at least one, or each, side portion of the frame module. The vehicle attachment members may be located on the perimeter of the frame module. The vehicle attachment members may be located on the outer edges of the frame module.

The one or more vehicle attachment members may be located on a lower surface of the frame module.

Each frame module may be attachable to the vehicle such that it is located substantially on the base portion of the vehicle. Each frame module may be attachable to the vehicle such that it is located substantially on the load carrying area of the vehicle.

Each frame module may include one or more support legs, or leg members. Each frame module may include a plurality of support legs, or leg members. The one or more support legs, or leg members, may be configured to provide support to the frame module. The one or more support legs, or leg members, may be configured to provide support to the frame module when the frame module is attached to the base portion of the vehicle.

The one or more support legs, or leg members, may be located on the lower surface of the frame module. The one or more support legs, or leg members, may be located on the front portion, rear portion, or side portions of the frame module. The one or more support legs, or leg members, may be located on at least one, or each, side portion of the frame module. The support legs, or leg members, may be located on the perimeter of the frame module. The support legs, or leg members, may be located on the outer edges of the frame module.

The one or more vehicle attachment members may be located on the support legs/leg members. The one or more vehicle attachment members may be located on the lower portion of the support legs/leg members.

The vehicle attachment members of the support legs/leg members may be configured to engage with the support frame attachment points of the vehicle. In this arrangement the frame modules may be spaced from the load carrying area of the vehicle. That is, the frame modules may be raised from the base portion of the vehicle. In this arrangement the load carrying area of the vehicle is accessible, as the frame modules are located above the load carrying area.

Where the vehicle attachment members of the frame modules are attached to the frame attachment points on the side portions/wall members of the vehicle, the frame modules may be spaced from the load carrying area of the vehicle. That is, the frame modules may be raised from the base portion of the vehicle. In this arrangement the load carrying area of the vehicle is accessible, as the frame modules are located above the load carrying area.

The vehicle attachment members may include releasable fastening devices. The vehicle attachment members may include mechanical fastening devices. The vehicle attachment members may include a nut and bolt fastening device, or the like.

The vehicle attachment members may be arranged to correspond to the frame attachment points of the vehicle.

The at least two frame modules may be releasably detachable from one another.

Each frame module may be attachable to the other at a plurality of locations.

The frame modules may be attachable in the direction of the longitudinal axis. The frame modules may be attachable in the direction of the lateral axis. The frame modules may be attachable in the direction of the vertical axis. The frame modules may be attachable in the direction of the longitudinal axis, lateral axis, and/or vertical axis.

The frame modules may be arranged vertically. The frame modules may be stacked. The frame modules may be stacked vertically. The frame modules may be arranged horizontally.

Each frame module may include at least one frame module attachment member. The at least one frame module attachment member may be configured to engage with a corresponding frame module attachment member of the other frame module.

The frame module attachment members may be complimentary to one another. The frame modules may have complementary frame receiving portions capable of engaging with the frame attachment portion of another frame module in a reversible manner. The frame attachment and receiving portions may be secured in place to prevent movement of the frame modules relative to one another. The frame attachment and receiving portions may secure the frame modules together in a manner which is permanent. The frame attachment and receiving portions may secure the frame modules together in a manner which is reversible. The frame modules may be secured together using a nuts and bolts, tracks, lugs, slots, pins, magnets, or the like.

The at least one frame module attachment member may be configured to allow the frame modules to be secured together. The at least one frame module attachment member may be configured to allow the frame modules to be releasably secured together.

The at least one frame module attachment member may be located on the front portion, rear portion, side portions, upper portion, or lower portion of the frame module. The at least one frame module attachment member may be located on the outer edges of the frame module. Each frame module may include a plurality of frame module attachment members. Each frame module attachment member may be located on a front portion, rear portion, side portion, upper portion, or lower portion of the frame module.

Each frame module may comprise a plurality of frame module attachment members. Each frame module attachment member may be located on a different portion of the frame module. Each frame module attachment member may be located on a front portion, a rear portion, a side portion, an upper portion, or a lower portion of the frame module.

Each frame module may comprise a frame module attachment member on each portion thereof. Each frame module may comprise one or more frame module attachment members on each portion thereof. The, or each, frame module attachment member may be located on an edge portion, or side portion, of the frame module.

The, or each, frame module attachment member may include a releasable fastening device. The, or each, frame module attachment member may include a mechanical fastening device. The, or each, frame module attachment member may include a nut and bolt fastening device, a slot and pin, a hook and slot, hook and clip, or the like.

The modular support frame may comprise a plurality of frame modules.

Each frame module may be configured to be attachable to another frame module at more than one location. Each frame module may be configured to be attachable to another frame module at a plurality of locations.

The frame modules may be attachable in the direction of the longitudinal axis. The frame modules may be attachable in the direction of the lateral axis. The frame modules may be attachable in the direction of the vertical axis. The frame modules may be attachable in the direction of the longitudinal axis, the lateral axis, and/or the vertical axis.

The frame modules may be arranged vertically. The frame modules may be stacked. The frame modules may be stacked vertically. The frame modules may be arranged horizontally. The frame modules may be arranged vertically and/or horizontally.

Each of the frame modules may include at least one frame module attachment member. Each of the frame modules may include a plurality of frame module attachment members. Each of the frame modules may be a releasable fastening member.

The frame modules may be arranged in series. The frame modules may be arranged in chains. The frame modules may be arranged in blocks. The frame modules may be arranged in parallel.

The frame modules of the modular support frame may be interchangeable. The position of the frame modules of the modular support frame may be varied. The frame modules of the modular support frame may be removed. The frame modules of the modular support frame may be repositioned. The frame modules of the modular support frame may be repositioned at more than one location. The configuration of the frame modules may be varied by altering the position of any frame module.

The modular support frame may further comprise a frame module support member. The frame module support member may be configured to provide support to at least two frame modules that are spaced apart from one another.

The frame module support member may be configured to be attachable to at least one of the frame modules. The frame module support member may be configured to be attachable to the frame modules. The frame module support member may be configured to be releasably attachable to the frame modules.

The frame module support member may be locatable between two frame modules. The frame module support member may be a brace member. The frame module support member may be a strut member. The frame module support member may be a crossbeam.

The frame module support member may provide support to the frame modules in the direction of the longitudinal, lateral, or vertical axis of the modular support frame.

The frame module support member may traverse the base portion of the vehicle. The frame module support member may traverse the load carrying area of the vehicle. The frame module support member may be spaced from the base portion/load carrying area of the vehicle.

The frame module support member may be configured to provide support to frame modules that are located on either side of the vehicle, or between the front and rear of the vehicle. The frame module support member may be configured to provide support to the frame modules to prevent collapse of the frame modules. The frame module support member may provide rigidity to the modular support frame. The frame module support member may be capable of carrying a load.

The frame module support member may be attachable to the base portion of the vehicle. The frame module support member may be attachable to the side portions/wall members of the vehicle.

The frame module support member may be attachable to the frame member attachment points of the vehicle.

The modular support frame may comprise two or more frame module support members. The modular support frame may comprise a plurality of frame module support members. Each frame module support member may be configured to provide support to at least two frame modules that are spaced apart from one another.

The frame module support members may be lateral support members. The frame module support members may be positioned in the direction of the lateral axis of the vehicle/modular support frame. The frame module support members may be longitudinal support members. The frame module support members may be positioned in the direction of the longitudinal axis of the vehicle/modular support frame.

The modular support frame may comprise a plurality of frame module support members. Each frame module support member may be configured to provide support to at least two frame modules that are spaced apart from one another.

Each frame module support member may be configured to be attachable to at least one of the frame modules. Each frame module support member may be configured to be attachable to the frame modules. Each frame module support member may be configured to be releasably attachable to the frame modules.

Each frame module support member may be locatable between two frame modules. Each frame module support member may be a brace member. Each frame module support member may be a strut member. Each frame module support member may be a crossbeam.

Each frame module support member may be configured to provide support to frame modules that are located on either side of the vehicle, or between the front and rear of the vehicle. The frame module support members may be configured to provide support to the frame modules to prevent collapse of the frame modules. The frame module support members may provide rigidity to the modular support frame. The frame module support members may be capable of carrying a load.

Each frame module support member may be attachable to the base portion of the vehicle. Each frame module support member may be attachable to the side portions/wall members of the vehicle.

Each frame module support member may be attachable to the frame member attachment points of the vehicle.

Each frame module support member may be a lateral support member. Each frame module support member may be positioned in the direction of the lateral axis of the vehicle/modular support frame. Each frame module support member may be a longitudinal support member. Each frame module support member may be positioned in the direction of the longitudinal axis of the vehicle/modular support frame.

The, or each, frame module support member may be attachable to the frame module attachment member on each frame module. The, or each, frame module support member may include a frame module attachment member. The frame module attachment member may include a releasable fastening device. The frame module attachment member may be a mechanical fastening device. The frame module attachment member may include a nut and bolt fastening device, a slot and pin, a hook and slot, hook and clip, or the like.

The frame module support member may be one of the at least two frame modules. The frame module support member may be an example of a frame module of the modular support frame of the present invention.

The frame module support member may be a first frame module and the other of the at least two frame modules may be a second frame module. The frame module support member may be attachable to the vehicle and the other frame module may be attachable to the frame module support member. The other frame module may also be attachable to the vehicle.

The frame module support member may be configured to provide support to the other frame module. The other frame module may be configured to provide support to an article or object mounted thereon, or thereto.

In this arrangement the frame module support member is directly attached to the vehicle and the other frame module is attached to the frame module support member. The other frame module may additional be attached to the vehicle.

Each frame module support member may be a frame module of the modular support frame.

The modular support frame may further comprise a frame module support member. The modular support frame may further comprise at least one frame module support member.

The frame module support member may be configured to provide support to the at least two frame modules. The at least two frame modules may be attachable to the frame module support member. The frame module support member may be attachable to the vehicle and the at least two frame modules may be attachable to the frame module support member. In this arrangement the at least two frame modules are not directly attached to the vehicle. In this arrangement the at least two frame modules are indirectly attached to the vehicle via the frame module support member.

Each frame module may be releasably engageable with the frame module support member.

The frame module support member may have a longitudinal axis. The longitudinal axis may extend between a front portion and rear portion of the frame. The frame module support member may have a lateral axis. The lateral axis may extend between each side of the frame. The frame module support member may have a vertical axis. The vertical axis may be perpendicular to the longitudinal axis and the lateral axis. The three axes may be orthogonally arranged.

The frame module support member may be a structural support member. The frame module support member may be constructed of a plurality of structural members. The plurality of structural members may be arranged to construct the support member. The frame module support member may be a frame member.

Each structural support member may be an elongate frame member. The structural support members may be fixedly attachable to one another to form the frame module support member. The structural support members may be releasably attachable to one another to form the frame module support member. The plurality of structural members may be fixedly attached by welding, gluing, or riveting, or the like, to construct the frame module support member.

The frame module support member may be made from metal, aluminium, metal alloy, fibre composites (e.g., glass fibre, carbon fibre etc.), plastic, recycled plastic, timber, laminated timber, ceramics, or the like.

The structural support members may be made from metal, aluminium, metal alloy, fibre composites (e.g., glass fibre, carbon fibre etc.), plastic, recycled plastic, timber, laminated timber, ceramics, or the like.

The frame module support member may be configured such that it may be installed in the vehicle. The frame module support member may be installed in the vehicle such that its longitudinal axis is substantially parallel to the longitudinal axis of the vehicle. The frame module support member may be installed in the vehicle such that its lateral axis is substantially parallel to the lateral axis of the vehicle. The frame module support member may be installed in the vehicle such that its vertical axis is substantially parallel to the vertical axis of the vehicle.

The frame module support member may be installed in the vehicle such that it extends in the direction of the longitudinal, lateral, and/or vertical axis.

The frame module support member may be configured such that it is attachable to the vehicle. The frame module support member may be configured such that it is releasably attachable to the vehicle. The frame module support member may be fixedly attachable to the vehicle. The frame module support member may be fixedly attached to the vehicle. The frame module support member may be fixedly attached to the vehicle by welding, gluing, bolting, riveting, or the like.

The frame module support member may be fixed to the vehicle. The frame module support member may be installed in the vehicle in such a manner that it may be removed from the vehicle. The frame module support member may be removably attachable to the vehicle.

The frame module support member may be attached to the vehicle by an adhesive. The frame module support member may be attached to the vehicle by magnetic force.

The frame module support member may be attachable to the base portion/floor portion of the vehicle. The frame module support member may be attachable to the load carrying area of the vehicle.

The frame module support member may be attachable to the least one area, or space, between the side portion of the vehicle and the load carrying area of the vehicle. The frame module support member may be attachable to each area, or space, between the side portion of the vehicle and the load carrying area of the vehicle. The frame module support member may be attachable to the least one area, or space, between the front portion of the vehicle and the load carrying area of the vehicle. The frame module support member may be attachable to the least one area, or space, between the rear portion of the vehicle and the load carrying area of the vehicle. The frame module support member may be attachable to the least one area, or space, between each side portion of the vehicle and the load carrying area of the vehicle, the area, or space, between the front portion of the vehicle and the load carrying area of the vehicle, and the area, or space, between the rear portion of the vehicle and the load carrying area of the vehicle.

The frame module support member may be attachable to the vehicle such that it is spaced from the base portion of the vehicle. In this arrangement the frame module support member may be spaced from the load carrying area of the vehicle. That is, the frame module support member may be raised from the base portion/load carrying area of the vehicle. In this arrangement the load carrying area of the vehicle is accessible, as the frame module support member is located above the load carrying area.

The frame module support member may be substantially parallel, or perpendicular, to the base portion/load carrying area of the vehicle.

The raised modular support frame may allow for additional storage within the vehicle underneath the modular support frame. The substantially raised modular support frame may allow for the installation of a further floor, or base portion, in the vehicle. The substantially raised modular support frame may allow for the installation of an underfloor heating module within the vehicle. The substantially raised modular support frame may allow for an increased volume of air above an underfloor heating module so as to improve the flow of hot air within the vehicle. The substantially raised modular support frame may allow for enhanced aesthetic qualities of the interior of the vehicle. The substantially raised modular support frame may improve the aesthetic appearance of the interior of the vehicle. The substantially raised modular support frame may improve the aesthetic quality of the interior of the vehicle. The substantially raised modular support frame may create the impression of an increased space and/or volume within the vehicle. The substantially raised modular support frame may create the visible impression of an increased space and/or volume within the vehicle.

The frame module support member may be attachable to the one or more side portions of the vehicle. The frame module support member may be attachable to the side portions/wall members of the vehicle. The frame module support member may be attachable to each side portion/wall member of the vehicle. The frame module support member may be attachable to oppositely facing side portions/wall members of the vehicle.

In this arrangement the frame module support member may be spaced from the base portion of the vehicle. In this arrangement the frame module support member may be spaced from the load carrying area of the vehicle. That is, the frame module support member may be raised from the base portion of the vehicle. In this arrangement the load carrying area of the vehicle is accessible, as the frame module support member is located above the load carrying area.

The frame module support member may be attachable to the one or more attachment points of the vehicle. The frame module support member may be attachable to the one or more support frame attachment points of the vehicle.

The frame module support member may include one or more vehicle attachment members. The one or more vehicle attachment members may be configured to engage with the one or more attachment points/support frame attachment points of the vehicle.

The frame module support member may have a front portion, a rear portion and two side portions.

The one or more vehicle attachment members may be located on the front portion, rear portion, or side portions of the frame module support member. The one or more vehicle attachment members may be located on the at least one, or each, side portion of the frame module support member. The vehicle attachment members may be located on the perimeter of the frame module support member. The vehicle attachment members may be located on the outer edges of the frame module support member.

The one or more vehicle attachment members may be located on a lower surface of the frame module support member.

The frame module support member may be attachable to the vehicle such that it is located substantially on the base portion of the vehicle. The frame module support member may be attachable to the vehicle such that it is located substantially on the load carrying area of the vehicle.

The frame module support member may include one or more support legs, or leg members. The frame module support member may include a plurality of support legs, or leg members. The one or more support legs, or leg members, may be configured to provide support to the frame module support member. The one or more support legs, or leg members, may be configured to provide support to the frame module support member when the frame module support member is attached to the base portion of the vehicle.

The one or more support legs, or leg members, may be located on the lower surface of the frame module support member. The one or more support legs, or leg members, may be located on the front portion, rear portion, or side portions of the frame module support member. The one or more support legs, or leg members, may be located on at least one, or each, side portion of the frame module support member. The support legs, or leg members, may be located on the perimeter of the frame module support member. The support legs, or leg members, may be located on the outer edges of the frame module support member.

The one or more vehicle attachment members may be located on the support legs/leg members. The one or more vehicle attachment members may be located on the lower portion of the support legs/leg members.

The vehicle attachment members of the support legs/leg members may be configured to engage with the support frame attachment points of the vehicle. In this arrangement the frame module support member may be spaced from the load carrying area of the vehicle. That is, the frame module support member may be raised from the base portion of the vehicle. In this arrangement the load carrying area of the vehicle is accessible, as the frame module support member is located above the load carrying area.

Where the vehicle attachment members of the frame module support member are attached to the frame attachment points on the side portions/wall members of the vehicle, the frame module support member may be spaced from the load carrying area of the vehicle. That is, the frame module support member may be raised from the base portion of the vehicle. In this arrangement the load carrying area of the vehicle is accessible, as the frame module support member is located above the load carrying area.

The vehicle attachment members may include releasable fastening devices. The vehicle attachment members may include mechanical fastening devices. The vehicle attachment members may include a nut and bolt fastening device, a slot and pin, a hook and slot, hook and clip, or the like.

The vehicle attachment members may be arranged to correspond to the frame attachment points of the vehicle. The location of the vehicle attachment members on the frame module support member may be arranged to align with the location of the one or more attachment points on the vehicle.

The modular support frame may further comprise one or more frame module support members. The modular support frame may further comprise a plurality of frame module support members. Each frame module support member may be configured to provide support to at least one frame module. At least one frame module may be attachable to each of the frame module support members. Each frame module support member may be installed in the vehicle such that it extends in the direction of the longitudinal, lateral, and/or vertical axis.

The frame module support member may be one of the at least two frame modules. The frame module support member may be an example of a frame module of the modular support frame of the present invention.

The frame module support member may be a first frame module and the other of the at least two frame modules may be a second frame module. The frame module support member may be attachable to the vehicle and the other frame module may be attachable to the frame module support member.

The frame module support member may be configured to provide support to the other frame module. The other frame module may be configured to provide support to an article or object mounted thereon, or thereto.

In this arrangement the frame module support member is directly attached to the vehicle and the other frame module is not directly attached to the vehicle.

Each frame module support member may be a frame module of the modular support frame.

The, or each, frame module may include one or more frame module support member attachment members. The one or more frame module support member attachment members may be configured to releasably engage/engage with the frame module support member.

The one or more frame module support member attachment members may be located on a rear, upper, side, or lower portion of the frame module. The one or more frame module support member attachment members may be located on the side edge (s) of the frame module. The one or more frame module support member attachment members may include releasable fastening devices. The vehicle attachment members may include mechanical fastening devices. The one or more frame module support member attachment members may include a nut and bolt fastening device, a slot and pin, a hook and slot, hook and clip, or the like.

At least one of the frame modules of the modular support frame may be a support module. At least one of the frame modules of the modular support frame may be configured to provide support to an article or object mounted thereon, or thereto.

The, or each, frame module/modular support frame may be configured to support an article, or object, above the base portion of the vehicle. The, or each, frame module/modular support frame may be configured to support an article, or object, above the load carrying area of the base portion of the vehicle.

The, or each, frame module/modular support frame may be configured to provide support to an article or object mounted thereon, or thereto.

The, or each, frame module/modular support frame may be configured to allow an article, or object, to be mounted thereto, thereon, or therein.

The, or each, frame module/modular support frame may be configured to receive an article, or object, substantially within the frame module.

The, or each, frame module/modular support frame may be configured to receive an article, or object, substantially on top of the frame module.

One of the frame modules may be a storage module. That is, one of the frame modules may be used to store one or more articles, or objects, therein, or thereon. The modular support frame may be used to store one or more articles, or objects, therein, or thereon.

The, or each, frame module/modular support frame may be configured to engage with the article, or object. The, or each, frame module/modular support frame may be configured to releasably engage with the article, or object.

The, or each, frame module/modular support frame may include one or more article, or object, attachment members. The one or more article, or object, attachment members may be configured to engage with the article, or object. The one or more article, or object, attachment members may be configured to releasably engage with the article, or object. The one or more article, or object, attachment members may be configured to engage with corresponding attachment members on the article, or object. The one or more article, or object, attachment members may be configured to secure the article, or object, to the, or each, frame module.

The article, or object, attachment members may include releasable fastening devices. The article, or object, attachment members may include mechanical fastening devices. The article, or object, attachment members may include a nut and bolt fastening device, a slot and pin, a hook and slot, hook and clip, or the like.

The, or each, frame module/modular support frame may receive and engage with the article, or object, via an interference fit. That is, the article, or object, may be held in place in, or on, the frame module/modular support frame by friction.

The frame modules may be substantially cuboid members. The frame modules may be substantially cuboid-shaped members. The frame modules may be substantially rectangular cuboids. The frame modules may be substantially rectangular-shaped cuboids.

The frame modules may have a length (L). The frame modules may have a width (W). The frame modules may have a height (H).

The lengths (L), widths (W) and heights (H) of the frame modules may be integer multiples. That is, the length (L) of the frame modules may be 2xL, 3xL, 4xL, etc. The width (W) of the frame modules may be 2xW, 3xW, 4xW, etc. The height (H) of the frame modules may be 2xH, 3xH, 4xH, etc. The frame modules may be double, triple, quadruple etc. length, width, or height.

The, or each, frame module/modular support frame may be configured to support a domestic, or retail, appliance, home appliance, household appliance, or retail appliance. Such a domestic, or retail, appliance, home appliance, or household appliance may include an oven, a stove, a cooking device, a dishwasher, a clothes dryer, a washing machine, a waste disposal unit, a refrigerator, a freezer, a microwave, an air conditioning unit, a water heater, a trash/waste compactor, an induction cooker, an electric mixer, coffee grinder, coffee machine, a medical device, an emergency response device, or the like.

The, or each, frame module/modular support frame may be configured to support an entertainment and information appliance, Such an entertainment and information appliance may include a home electronics device, a radio receiver, a television set, a music stereo system, a personal computer, a mobile telecommunication device, a medical device, an emergency response device, a navigation device, a data gathering device, a camera, a GPS device, or the like.

The, or each, frame module/modular support frame may be configured to support an amenity, such as a domestic, or retail, amenity. Such an amenity may include a shower, sofa, sofa bed, a bed, a bath, a worktop, a couch, a chair, a table, a sink, a storage unit, a cupboard, a cabinet, a shelf, a drawer, a drying box, a desk, a heating device, a table, or the like.

The modular support frame may be configured to support a plurality of domestic, or retail, appliances, home appliances, or household appliances. The modular support frame may be configured to support a plurality of entertainment and information appliances. The modular support frame may be configured to support a plurality of amenities, domestic, or retail, amenities, or the like.

The one or more articles, amenities or appliances may be objects required for the function of the environment within the vehicle. That is, the articles, amenities and appliances may be relevant for the living/working environment intended within the vehicle.

The, or each, frame module may be configured to receive a supply of electricity. The, or each, frame module may include one or more electrical power supply sockets.

According to a second aspect of the present invention there is provided a modular support frame for a vehicle comprising:
at least two frame modules,
wherein the at least two frame modules are configured to be attachable to one another at more than one location, and
wherein one of the frame modules includes a domestic/retail appliance, or domestic/retail amenity.

The modular support frame may include a plurality of frame modules. Each frame module may include a domestic/retail appliance, or domestic/retail amenity.

Embodiments of the second aspect of the present invention may include one or more features of the first aspect of the present invention or its embodiments. Similarly, embodiments of the first aspect of the present invention may include one or more features of the second aspect of the present invention or its embodiments.

According to a third aspect of the present invention there is provided a frame module for a modular support frame of a vehicle comprising:
a domestic/retail appliance, or domestic/retail amenity, and
wherein the frame module is configured to be attachable to a further frame module of the modular support frame.

Embodiments of the third aspect of the present invention may include one or more features of the first or second aspects of the present invention or their embodiments. Similarly, embodiments of the first or second aspects of the present invention may include one or more features of the third aspect of the present invention or its embodiments.

According to a fourth aspect of the present invention there is provided a vehicle comprising:
a modular support frame for a vehicle comprising:
   at least two frame modules,
   wherein the at least two frame modules are configured to be attachable to one another at more than one location.

Embodiments of the fourth aspect of the present invention may include one or more features of the first, second or third aspects of the present invention or their embodiments. Similarly, embodiments of the first, second or third aspects of the present invention may include one or more features of the fourth aspect of the present invention or its embodiments.

According to a fifth aspect of the present invention there is provided a vehicle comprising:

a modular support frame for a vehicle comprising:
at least two frame modules,
wherein the at least two frame modules are configured to be attachable to one another at more than one location, and
wherein one of the frame modules includes a domestic/retail appliance, or domestic/retail amenity.

Embodiments of the fifth aspect of the present invention may include one or more features of the first, second, third, or fourth aspects of the present invention or their embodiments. Similarly, embodiments of the first, second, third or fourth aspects of the present invention may include one or more features of the fifth aspect of the present invention or its embodiments.

According to a sixth aspect of the present invention there is provided a method of installing a modular support frame to a vehicle, the method comprising the steps of:
providing a modular support frame for a vehicle comprising:
   at least two frame modules,
   wherein the at least two frame modules are configured to be attachable to one another at more than one location;
attaching the at least two frame modules together in a desired configuration;
positioning the modular support frame within the vehicle;
aligning one or more vehicle attachment points of the modular support frame with one or more modular support frame attachment points of the vehicle; and
attaching the modular support frame to the vehicle.

The one or more modular frame attachment points may be located on the base portion of the vehicle. The one or more modular frame attachment points may be located on the load carrying area of the vehicle. The one or more modular frame attachment points may be located outside the load carrying area of the vehicle.

The one or more modular frame attachment points may be located in an area, or space, between a side portion of the vehicle and the load carrying area of the vehicle. The one or more modular frame attachment points may be located in an area, or space, between each side portion of the vehicle and the load carrying area of the vehicle. The one or more modular frame attachment points may be located in an area, or space, between the front portion of the vehicle and the load carrying area of the vehicle. The one or more modular frame attachment points may be located in an area, or space, between the rear portion of the vehicle and the load carrying area of the vehicle.

The one or more modular frame attachment points may be located in an area, or space, between each side portion of the vehicle and the load carrying area of the vehicle, and an area, or space, between the front portion of the vehicle and the load carrying area of the vehicle.

The one or more modular frame attachment points may be located in an area, or space, between each side portion of the vehicle and the load carrying area of the vehicle, and an area, or space, between the rear portion of the vehicle and the load carrying area of the vehicle.

The one or more modular frame attachment points may be located in an area, or space, between each side portion of the vehicle and the load carrying area of the vehicle, an area, or space, between the front portion of the vehicle and the load carrying area of the vehicle, and an area, or space, between the rear portion of the vehicle and the load carrying area of the vehicle.

The one or more modular frame attachment points may be located on at least one of the side portions/wall members of the vehicle. The one or more modular frame attachment points may be located on each side portion/wall member of the vehicle.

The one or more modular frame attachment points may be located on at least one of the side portions/wall members of the vehicle and the front portion of the vehicle.

The one or more modular frame attachment points may be located on at least one of the side portions/wall members of the vehicle and the rear portion of the vehicle.

The one or more modular frame attachment points may be located on at least one of the side portions/wall members of the vehicle, the front portion of the vehicle, and the rear portion of the vehicle.

The one or more modular frame attachment points may be arranged to lie on a plane. The one or more modular frame attachment points may be arranged to lie on two planes. The one or more modular frame attachment points may be arranged to lie on the same plane. The one or more modular frame attachment points may be arranged to lie on two different planes. The one or more modular frame attachment points may be arranged to be the same height from the base portion of the vehicle. Alternatively, the one or more modular frame attachment points may be arranged to lie on different planes. Alternatively, the one or more modular frame attachment points may be arranged to be at different heights from the base portion of the vehicle.

The modular frame attachment points may be located outside the load carrying area of the vehicle.

The modular support frame may include one or more support legs, or leg members. The one or more vehicle attachment members may be located on the lower portion of the support legs/leg members.

In this arrangement the modular support frame may be spaced from the base portion/load carrying area of the vehicle. That is, the modular support frame may be raised from the base portion/load carrying area of the vehicle. In this arrangement the load carrying area of the vehicle is accessible, as the modular support frame is located above the load carrying area.

The method may comprise the further step of detaching one of the frame modules from the other frame module and the vehicle, and reattaching the frame module to the other frame module and vehicle at a different location.

The modular support frame may include a plurality of frame modules. Each frame module may be removably attachable to another frame module, and vehicle, at a number of different locations.

Embodiments of the sixth aspect of the present invention may include one or more features of the first, second, third, fourth or fifth aspects of the present invention or their embodiments. Similarly, embodiments of the first, second, third, fourth or fifth aspects of the present invention may include one or more features of the sixth aspect of the present invention or its embodiments.

According to a seventh aspect of the present invention there is provided a method of installing a modular support frame to a vehicle, the method comprising the steps of:
providing a modular support frame for a vehicle comprising:
   at least two frame modules,
   wherein the at least two frame modules are configured to be attachable to one another at more than one location;
positioning a first frame module at a first location within the vehicle;
aligning one or more vehicle attachment points of the first frame module with one or more modular support frame attachment points of the vehicle;
attaching the first frame module to the vehicle;
positioning a second frame module at a second location within the vehicle;
aligning one or more vehicle attachment points of the second frame module with one or more modular support frame attachment points of the vehicle;
attaching the second frame module to the vehicle; and
attaching the first and second frame modules together.

The method may comprise the further step of detaching one of the frame modules from the other frame module and the vehicle, and reattaching the frame module to the other frame module and vehicle at a different location.

The modular support frame may include a plurality of frame modules. Each frame module may be removably attachable to another frame module, and vehicle, at a number of different locations.

Embodiments of the seventh aspect of the present invention may include one or more features of the first, second, third, fourth, fifth or sixth aspects of the present invention or their embodiments. Similarly, embodiments of the first, second, third, fourth, fifth or sixth aspects of the present invention may include one or more features of the seventh aspect of the present invention or its embodiments.

According to an eighth aspect of the present invention there is provided a method of installing a modular support frame to a vehicle, the method comprising the steps of:
providing a modular support frame for a vehicle comprising:
   at least two frame modules,
   wherein the at least two frame modules are configured to be attachable to one another at more than one location;
positioning a first frame module at a first location within the vehicle;
aligning one or more vehicle attachment points of the first frame module with one or more modular support frame attachment points of the vehicle;
attaching the first frame module to the vehicle;
positioning a second frame module at a second location within the vehicle; and
attaching the first and second frame modules together.

The method may comprise the further step of detaching one of the frame modules from the other frame module, and reattaching the frame module to the other frame module at a different location.

The modular support frame may include a plurality of frame modules. Each frame module may be removably attachable to another frame module at a number of different locations.

Embodiments of the eighth aspect of the present invention may include one or more features of the first, second, third, fourth, fifth, sixth or seventh aspects of the present invention or their embodiments. Similarly, embodiments of the first, second, third, fourth, fifth, sixth or seventh aspects of the present invention may include one or more features of the eighth aspect of the present invention or its embodiments.

According to a ninth aspect of the invention there is provided a support frame for a vehicle comprising:
one or more vehicle attachment members,
wherein the one or more vehicle attachment members are configured to engage with one or more frame attachment points of the vehicle.

The frame may be an integral member. The frame may be a one-piece member. The frame may include at least two frame modules. The frame may be non-modular. The frame modules may not be configured to be attachable to one another at more than one location. The frame modules may be fixedly attached to one another.

Embodiments of the ninth aspect of the present invention may include one or more features of the first, second, third, fourth, fifth, sixth, seventh, or eighth aspects of the present invention or their embodiments. Similarly, embodiments of the first, second, third, fourth, fifth, sixth, seventh, or eighth aspects of the present invention may include one or more features of the ninth aspect of the present invention or its embodiments.

According to a tenth aspect of the present invention there is provided a modular support frame for a vehicle comprising:
one or more frame modules; and
a frame module support member,
wherein the frame module support member is attachable to the vehicle and is configured to provide support to the one or more frame modules.

The modular support frame may comprise a plurality of frame modules. The one or more frame modules may be attachable to the frame module support member. The one or more frame modules may be releasably attachable to the frame module support member.

The frame module support member may be releasably attachable to the vehicle.

The modular support frame may comprise two or more frame module support members. Each frame module support member being attachable to the vehicle and being configured to provide support to one or more frame modules.

Embodiments of the tenth aspect of the present invention may include one or more features of the first, second, third, fourth, fifth, sixth, seventh, eighth, or ninth aspects of the present invention or their embodiments. Similarly, embodiments of the first, second, third, fourth, fifth, sixth, seventh, eighth, or ninth aspects of the present invention may include one or more features of the tenth aspect of the present invention or its embodiments.

According to an eleventh aspect of the present invention there is provided a modular support frame for a vehicle comprising:
one or more frame modules; and
a frame module support member,
wherein the frame module support member is attachable to the vehicle and is configured to provide support to the one or more frame modules, and
wherein one of the frame modules includes a domestic/retail appliance, or domestic/retail amenity.

Embodiments of the eleventh aspect of the present invention may include one or more features of the first, second, third, fourth, fifth, sixth, seventh, eighth, ninth, or tenth aspects of the present invention or their embodiments. Similarly, embodiments of the first, second, third, fourth, fifth, sixth, seventh, eighth, ninth, or tenth aspects of the present invention may include one or more features of the eleventh aspect of the present invention or its embodiments.

According to a twelfth aspect of the present invention there is provided a frame module for a modular support frame of a vehicle comprising:
a domestic/retail appliance, or domestic/retail amenity, and
wherein the frame module is configured to be attachable to a frame module support member of the modular support frame.

Embodiments of the twelfth aspect of the present invention may include one or more features of the first, second, third, fourth, fifth, sixth, seventh, eighth, ninth, tenth, or eleventh aspects of the present invention or their embodiments. Similarly, embodiments of the first, second, third, fourth, fifth, sixth, seventh, eighth, ninth, tenth, or eleventh aspects of the present invention may include one or more features of the twelfth aspect of the present invention or its embodiments.

According to a thirteenth aspect of the present invention there is provided a vehicle comprising:
one or more frame modules; and
a frame module support member,
wherein the frame module support member is attachable to the vehicle and is configured to provide support to the one or more frame modules.

Embodiments of the thirteenth aspect of the present invention may include one or more features of the first, second, third, fourth, fifth, sixth, seventh, eighth, ninth, tenth, eleventh, or twelfth aspects of the present invention or their embodiments. Similarly, embodiments of the first, second, third, fourth, fifth, sixth, seventh, eighth, ninth, tenth, eleventh, or twelfth aspects of the present invention may include one or more features of the thirteenth aspect of the present invention or its embodiments.

According to a fourteenth aspect of the present invention there is provided a vehicle comprising:
one or more frame modules; and
a frame module support member,
wherein the frame module support member is attachable to the vehicle and is configured to provide support to the one or more frame modules, and
wherein one of the frame modules includes a domestic/retail appliance, or domestic/retail amenity.

Embodiments of the fourteenth aspect of the present invention may include one or more features of the first, second, third, fourth, fifth, sixth, seventh, eighth, ninth, tenth, eleventh, twelfth, or thirteenth aspects of the present invention or their embodiments. Similarly, embodiments of the first, second, third, fourth, fifth, sixth, seventh, eighth, ninth, tenth, eleventh, twelfth, or thirteenth aspects of the present invention may include one or more features of the fourteenth aspect of the present invention or its embodiments.

According to a fifteenth aspect of the present invention there is provided a method of installing a modular support frame to a vehicle, the method comprising the steps of:
providing a modular support frame for a vehicle comprising:
   one or more frame modules; and
   a frame module support member,
wherein the frame module support member is attachable to the vehicle and is configured to provide support to the one or more frame modules
attaching the one or more frame modules to the frame module support member;
positioning the modular support frame within the vehicle;
aligning one or more vehicle attachment points of the modular support frame with one or more modular support frame attachment points of the vehicle; and
attaching the modular support frame to the vehicle.

Embodiments of the fifteenth aspect of the present invention may include one or more features of the first, second, third, fourth, fifth, sixth, seventh, eighth, ninth, tenth, eleventh, twelfth, thirteenth, or fourteenth aspects of the present invention or their embodiments. Similarly, embodiments of the first, second, third, fourth, fifth, sixth, seventh, eighth, ninth, tenth, eleventh, twelfth, thirteenth, or fourteenth aspects of the present invention may include one or more features of the fifteenth aspect of the present invention or its embodiments.

According to a sixteenth aspect of the present invention there is provided a method of installing a modular support frame to a vehicle, the method comprising the steps of:
providing a modular support frame for a vehicle comprising:
   one or more frame modules; and
   a frame module support member,
wherein the frame module support member is attachable to the vehicle and is configured to provide support to the one or more frame modules
positioning the frame module support member at a first location within the vehicle;
aligning one or more vehicle attachment points of the frame module support member with one or more modular support frame attachment points of the vehicle;
attaching the frame module support member frame module to the vehicle; and
attaching the one or more frame modules to the frame module support member.

Embodiments of the sixteenth aspect of the present invention may include one or more features of the first, second, third, fourth, fifth, sixth, seventh, eighth, ninth, tenth, eleventh, twelfth, thirteenth, fourteenth, or fifteenth aspects of the present invention or their embodiments. Similarly, embodiments of the first, second, third, fourth, fifth, sixth, seventh, eighth, ninth, tenth, eleventh, twelfth, thirteenth, fourteenth, or fifteenth aspects of the present invention may include one or more features of the sixteenth aspect of the present invention or its embodiments.

### BRIEF DESCRIPTION OF THE DRAWINGS

An embodiment of the invention will now be described, by way of example only, with reference to the drawings, in which:

FIG. 1a is a rear view of a vehicle to which the modular support frame/support frame of the present invention may be installed;

FIG. 1b is a top view of the base portion/load carrying area of the vehicle of FIG. 1a;

FIG. 1c is illustrates one example of support frame attachment points of the vehicle;

FIG. 2a is a top perspective view of the modular support frame/ support frame in accordance with the present invention;

FIG. 2b is a perspective view of a portion of the modular support frame/ support frame of FIG. 2a;

FIG. 2c is a side view of a frame module support member;

FIG. 2d is a top view of an alternate arrangement of the modular support frame/support frame of FIG. 2a;

FIG. 3 is a rear view of the vehicle of FIG. 1a with the modular support frame/support frame of FIG. 2a installed therein;

FIGS. 4a and 4b are partial end views of the modular support frame/ support frame installed in the vehicle of FIG. 3;

FIG. 5 is a partial end view of the modular support frame/support frame of FIG. 3 with two domestic appliances installed therein;

FIG. 6 is a rear view of the vehicle and modular support frame/support frame of FIG. 3 with a plurality of domestic amenities installed thereon; and

FIG. 7 is a partial view of the vehicle and modular support frame/support frame of FIG. 6 with objects stored on the load carrying area of the vehicle; and

FIGS. 8a to 8c are partial schematic representations of a frame module attachment member.

### DESCRIPTION OF PREFERRED EMBODIMENTS

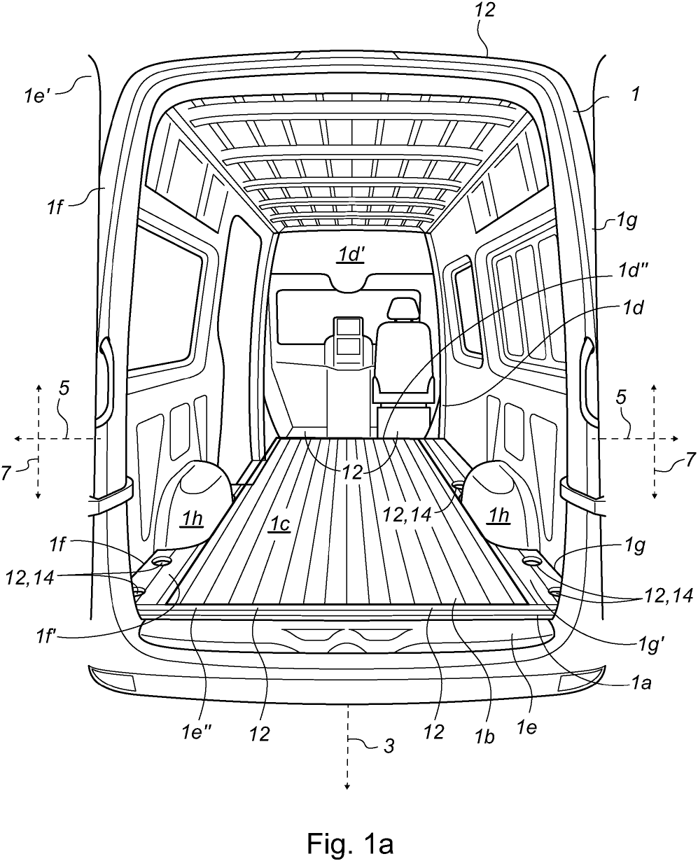

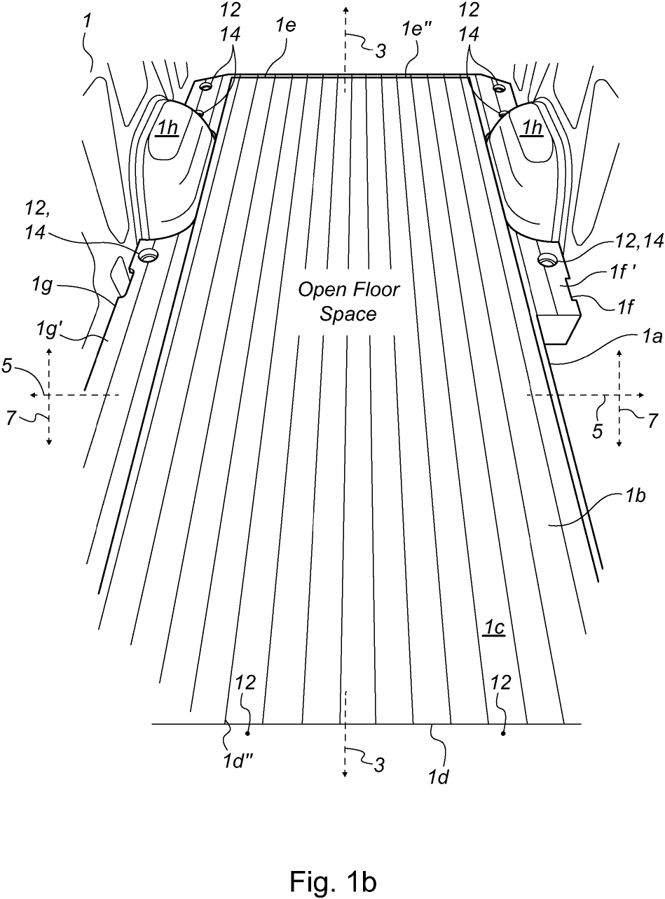

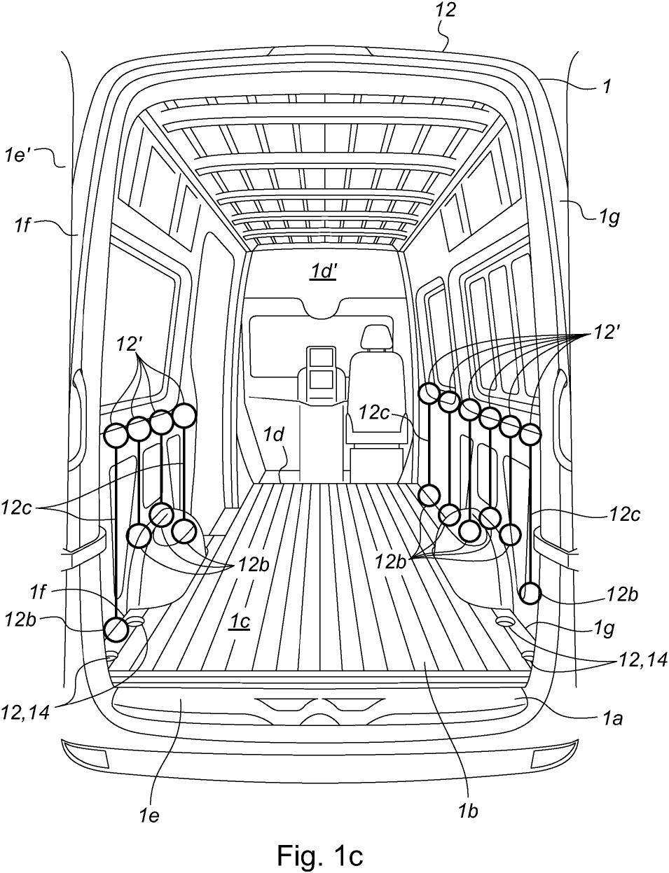

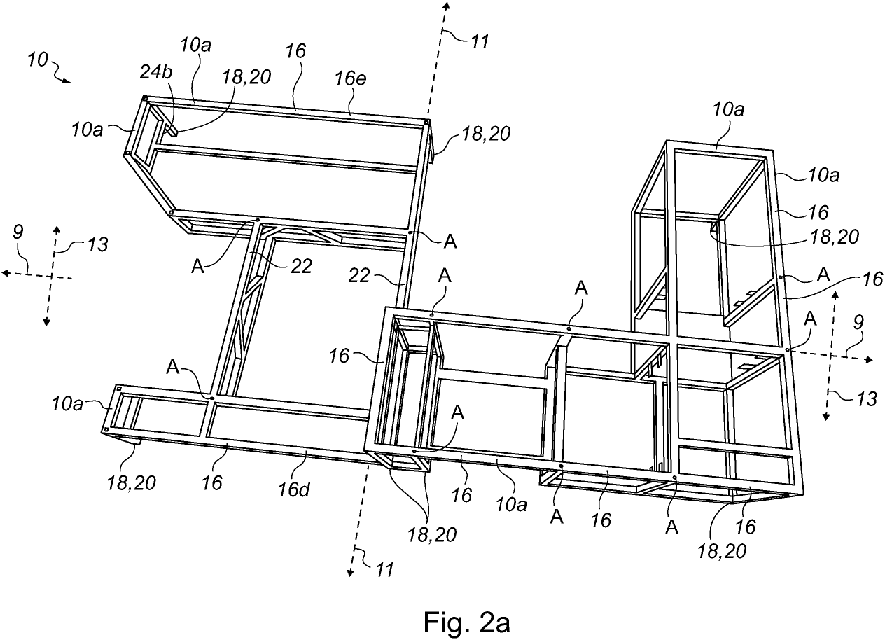

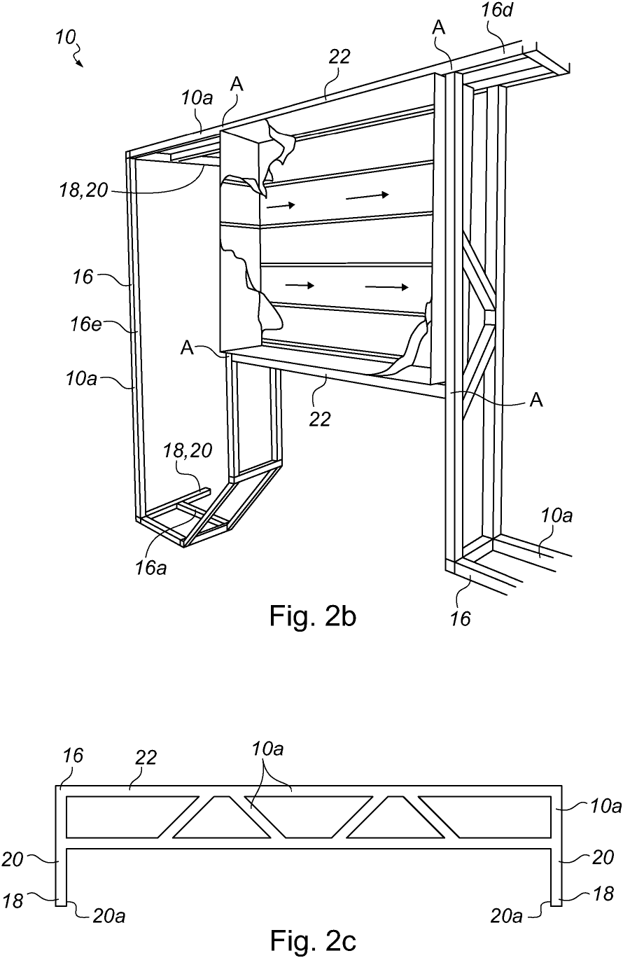

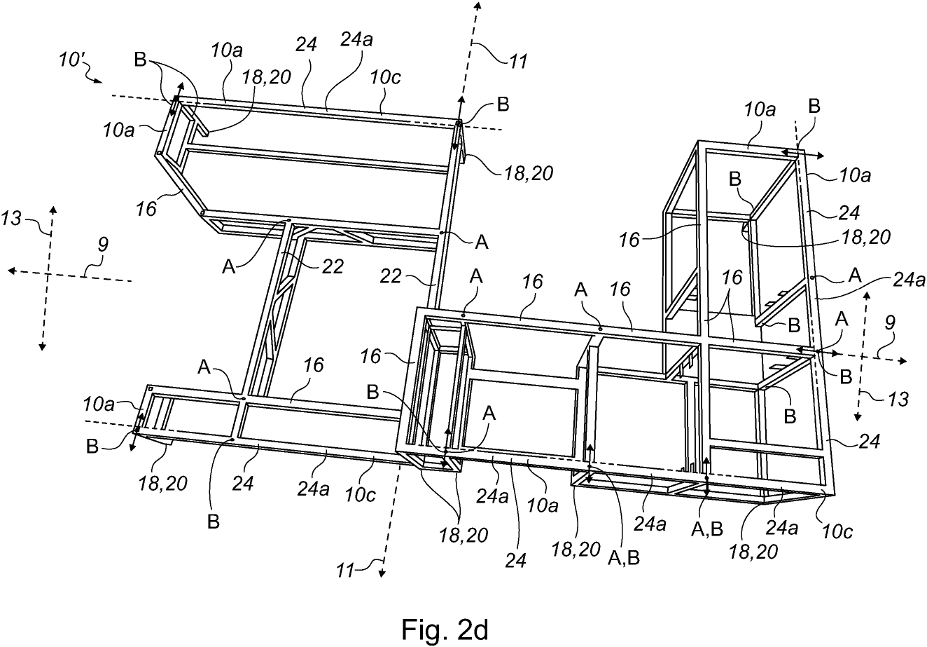

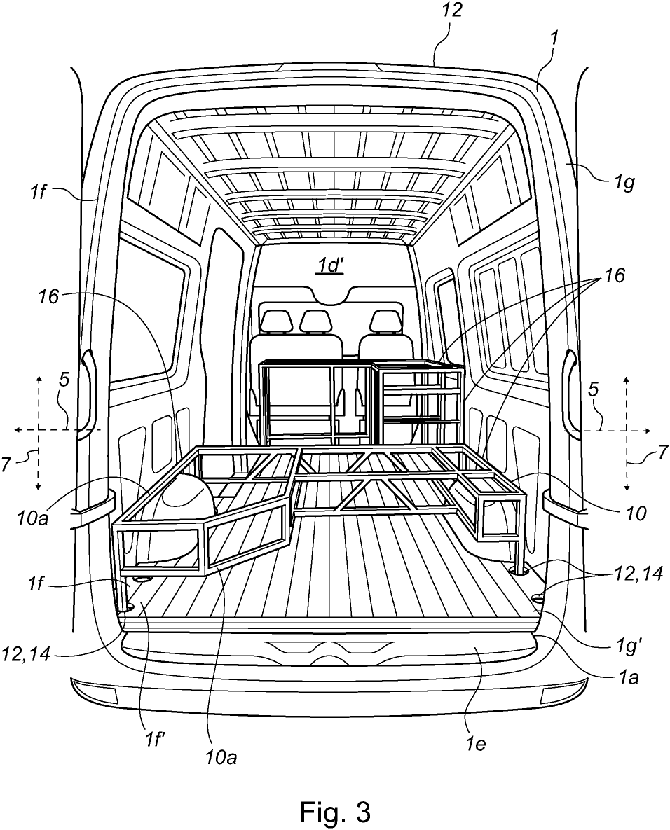

With reference to FIGS. 2a, 2b and 3, a modular support frame 10 for a vehicle 1 is illustrated. An example of a vehicle 1 to which the modular support frame 10 may be installed is illustrated in FIGS. 1a and 1b.

In the embodiment illustrated and described here, the vehicle 1 is a van. However, it should be appreciated that the vehicle may be a car, boat, ship, train, truck, lorry, mobile plant, emergency vehicle, campervan, motorhome, aircraft, or the like.

As best illustrated, the vehicle 1 includes a base portion 1a (floor portion), which includes a load carrying area 1b. The load carrying area 1b is capable of carrying a load. As illustrated, the load carrying area 1b is substantially rectangular in shape. The shape of the load carrying area 1b is defined by the front 1d, rear 1e and sides 1f and 1g (examples of side portions/wall members) of the vehicle 1. The width of the load carrying area 1b is defined, or limited, by the wheel arches 1h of the vehicle 1. In the embodiment illustrated and described here, the base portion 1a of the vehicle 1 includes wooden flooring 1c, which includes underfloor heating (not illustrated). However, it should be appreciated that the invention may be used with a vehicle that has not been floored, or the like.

As illustrated, the side portions 1f, 1g of oppositely facing and extend between the rear 1e and front 1d of the vehicle 1. For the purposes of the present invention, the front portion 1d of the vehicle is considered to be located behind the cab portion 1d′ of the vehicle 1. In the embodiment illustrated and described here, the front portion 1d is “open”. That is, there is no wall portion separating the load carrying area (or load carrying portion) 1b from the cab portion 1d′. However, it should be appreciated that a wall portion may be included on the vehicle 1. In such an arrangement, the wall portion may be considered a side portion, or wall member in accordance with the present invention. The side portion 1f and rear 1e of the vehicle 1 may include doors 1e′. The doors 1e′ being arranged to allow access to the inside of the vehicle 1 and the load carrying area 1b. The vehicle 1 also includes a roof potion 1i. Together, the roof portion 1i, the base portion 1a, the two side portions 1f and 1g, the front portion 1d and the rear portion 1e define the internal volume of the vehicle 1.

The vehicle 1 includes a longitudinal axis 3, a lateral axis 5 and a vertical axis 7. The three axes 3, 5 and 7 are orthogonally arranged.

As best illustrated in FIG. 1b, the load carrying area 1b of the vehicle 1 may be smaller than the area of the base portion 1a. As best illustrated in FIG. 1b, the load carrying area 1b of the vehicle 1 is located within the area of the base portion 1a. The vehicle 1 includes: an area 1f′ between the side portion 1f and the load carrying area 1b; an area 1g′ between the side portion 1g and the load carrying area 1b; an area 1e″ between the rear 1e and the load carrying area 1b; and an area 1d″ between the front 1d and the load carrying area 1b. The areas 1f′, 1g′, 1e″ and 1d″ are generally rectangular in shape and extend along the length or width of the vehicle 1. Areas 1f′ and 1g′ in particular are separate by the width of the load carrying area 1b (between the wheel arches 1h) of the vehicle 1.

As best illustrated in FIGS. 1a and 1b, areas 1f′, 1d″ and 1g′ of the base portion 1a include attachment points 12. The attachment points 12 are configured to allow one or more objects, or articles, to be attached thereto. The attachment points 12 are typically used to secure cargo within the vehicle during transport. The attachment points 12 may be configured to receive threaded screw members, bolt members, hooks, clips, or the like. Such attachment points 12 typically include D-rings, which may be screwed to the base portion 1a of the vehicle 1. Attachment points 12 are typically found in transport vehicles and the present invention is configured to engage with pre-existing attachment points 12. However, it should also be appreciated that it is also possible for new attachment points 12 to be created on the base portion 1a of the vehicle 1 as required. It should be appreciated that the access to the attachment portions 12 has been provided in the embodiment illustrated and described here by creating apertures 14 in the load carrying area 1b. It should also be appreciated that areas 1e″ may also include attachment points 12, although not illustrated.

The attachment points 12 are thus located outside the load carrying area 1b of the vehicle 1. In the embodiment illustrated and described here, the base portion 1a includes attachment points 12 on areas 1f′, 1d″ and 1g′. In this arrangement, the area 1d″ is considered as lying outside of the load carrying area 1b. However, ensuring that the attachment points 12 are located on areas 1f′and 1g′ may be considered as having a greater impact on maintaining the useable load carrying area 1b.

In the embodiment illustrated and described here, the attachment points 12 are support frame attachment points and are configured to receive and engage with the modular support frame 10, as described further below.

With reference to FIGS. 2a to 2c, the modular support frame 10 has a longitudinal axis 9, a lateral axis 11 and a vertical axis 13. The three axes 9, 11 and 13 are orthogonally arranged.

The modular support frame 10 is a structural support member constructed from a plurality of structural members 10a. Each structural member 10a is an elongate member. The structural members 10a may be attached together (fixedly, or releasably) to form the modular support frame 10.

The modular support frame 10 comprises a plurality of frame modules 16, as described further below. Each frame module 16 is configured to be attachable to another frame module 16 at more than one location.

Each frame module 16 is a structural support member and is constructed from a plurality of structural members 10a. The structural members 10a may be attached together (fixedly, or releasably) to form the frame modules 16.

The structural support members 10a may be made from metal, aluminium, metal alloy, fibre composites (e.g., glass fibre, carbon fibre etc.), plastic, recycled plastic, timber, laminated timber, ceramics, or the like.

The modular support frame 10 is configured such that it can be installed within the vehicle 1. The modular support frame 10 is installed in the vehicle 1 such that its longitudinal axis 9, lateral axis 11 and vertical axis 13 substantially matches the longitudinal axis 3, lateral axis 5 and vertical axis 7 of the vehicle 1.

As described further below, the modular support frame 10 is removably attachable to the vehicle 1. This allows the modular support frame 10 to be temporarily used with the vehicle 1. Alternatively, the modular support frame 10 may be fixedly attached to the vehicle 1.

With reference to FIGS. 2a to 4b, the modular support frame 10 is attachable to the base portion 1a of the vehicle 1. The modular support frame 10 is attached to the vehicle 1 at attachment points 12. The modular support frame 10 includes a plurality of vehicle attachment members 18. The vehicle attachment members 18 are configured to be releasably engageable with the attachment points 12 of the base portion 1a of the vehicle 1. The vehicle attachment members 18 are arranged to align with the attachment points 12 of the base portion 1a of the vehicle 1.

In the embodiment illustrated and described here, the modular support frame 10 includes a plurality of support legs 20 attached to a lower surface 10b thereof, and the vehicle attachment members 18 are located at lower portions 20a of each support leg 20. However, it should be appreciated that the modular support frame 10 may not include support legs 20, and that the vehicle attachment members 18 may be on the lower surface 10b of the modular support frame 10.

The support legs 20 are configured to provide support to the modular support frame 10. The support legs 20 are also configured to space the modular support frame 10 from the base portion 1a/load carrying area 1b. That is, the support legs 20 raise the modular support frame 10 from the base portion 1a/load carrying area 1b. As described further below, in this arrangement the load carrying area 1b of the vehicle 1 is accessible, as the modular support frame 10 is located above the load carrying area 1b.

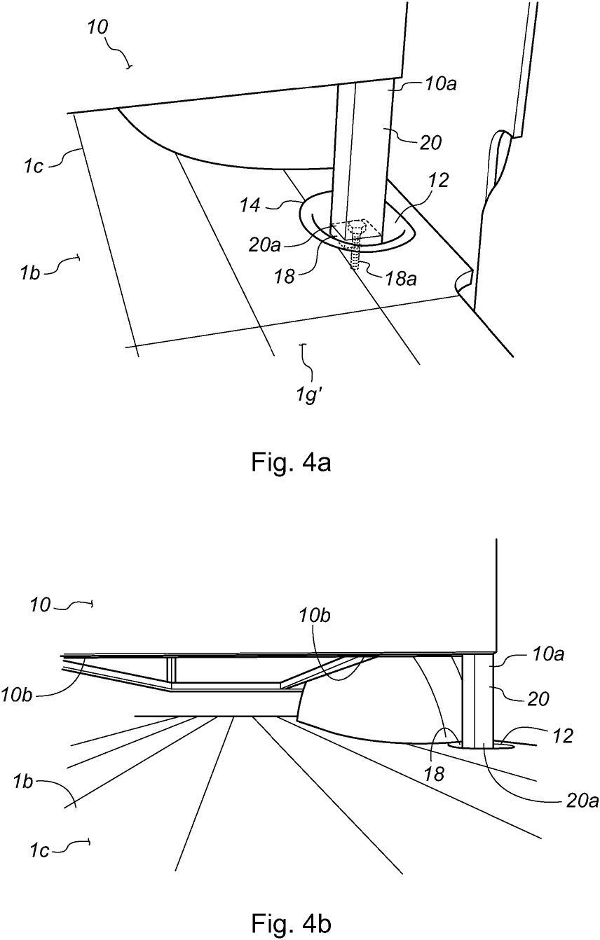

In the embodiment illustrated and described here, the vehicle attachment members 18 are threaded bolts and nuts 18a (an example of a releasable fastening device/mechanical fastening device). However, it should be appreciated that other suitable releasable fastening devices may be used. As illustrated partially schematically in FIG. 4a, the vehicle attachment member 18 of the modular support frame 10 is attached to the base portion 1a of the vehicle 1 with the threaded bolt and nut 18a. The threaded bolt and nut 18a is located within the support leg 20 of the modular support frame 10 and passes through the lower portion 20a into the attachment point 12 of the base portion 1a. As described above, the attachment point 12 is configured to receive and engage with a threaded member. The modular support frame 10 may therefore be releasably secured to the base portion 1a of the vehicle 1.

FIG. 3 illustrates the modular support frame 10 installed in the vehicle 1. As illustrated, the modular support frame 10 is attached to the base portion 1a of the vehicle 1 outside the load carrying area 1b.

As described above, the modular support frame 10 comprises a plurality of frame modules 16. Each frame module 16 is configured to be attachable to another frame module 16 at more than one location, or a plurality of locations. Together, the attached frame modules 16 form the modular support frame 10.

Each frame module 16 may be connected together at points A, as illustrated. Each frame module 16 includes at least one frame module attachment member located at point A. Each frame module attachment member is configured to allow each frame module 16 to be releasably attachable to another frame module 16. In the embodiment illustrated and described here, the frame module attachment members are threaded bolts and nuts (an example of a releasable fastening member). However, it should be appreciated that other suitable fastening devices may be used. However, it should be appreciated the frame modules 16 may be configured differently, as required.

In the embodiment illustrated and described here, and best illustrated in FIGS. 2a to 2c, the modular support frame 10 includes eight frame modules. It should be appreciated that each frame module 16 may be releasably attachable to another frame module 16 at more than one location.

Each frame module 16 may be releasably attachable to the base portion 1a of the vehicle 1. That is, each frame module 16 may be attachable separately/independently to the base portion 1a of the vehicle 1. In this arrangement, each frame module 16 is attached to the attachment points 12 of the vehicle 1.

Each frame module 16 therefore includes one or more attachment members 18 and are attached to the base portion 1a of the vehicle 1 in same manner as described above in relation to the modular support frame 10. Each frame module 16 includes support legs 20 located on the lower surface 16a thereof. Again, the vehicle attachment members 18 are arranged to align with the attachment points 12 of the base portion 1a of the vehicle 1.

Again, the support legs 20 raise each frame module 16 from the base portion 1a of the vehicle 1.

As described further below, with each frame module 16 being removably attachable to the vehicle 1, this allows the configuration of the modular support frame 10 to be altered to suit the requirements of the user of the vehicle 1. The frame modules 16 of the modular support frame 10 may be interchangeable. The frame modules 16 of the modular support frame 10 may be repositioned at more than one location. Thus, the configuration of the frame modules 16 may be varied by altering the position of any frame module 16.

Also, again it follows that each frame module 16 is attached to the base portion 1a of the vehicle 1 outside the load carrying area 1b, such that the formed modular support frame 10 is also attached to the base portion 1a of the vehicle 1.

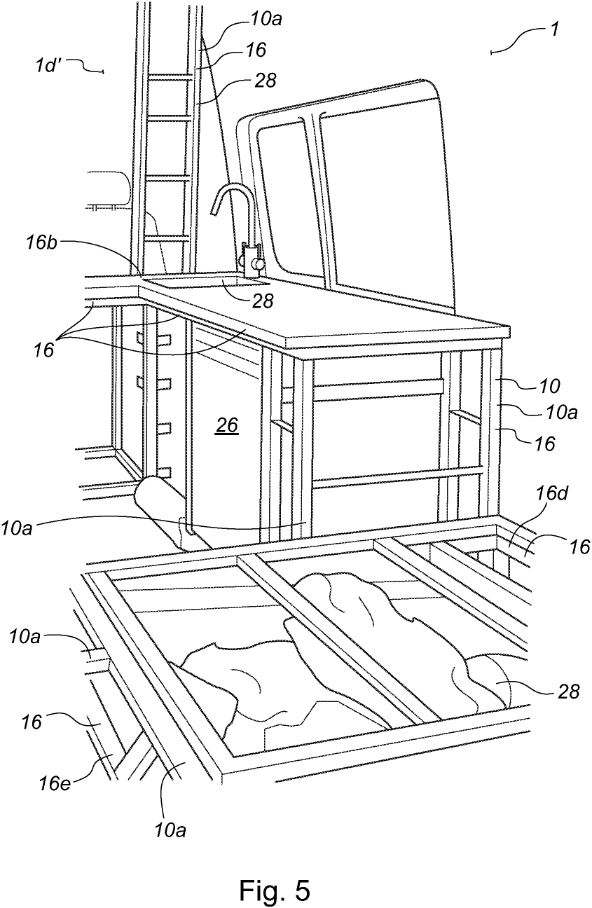

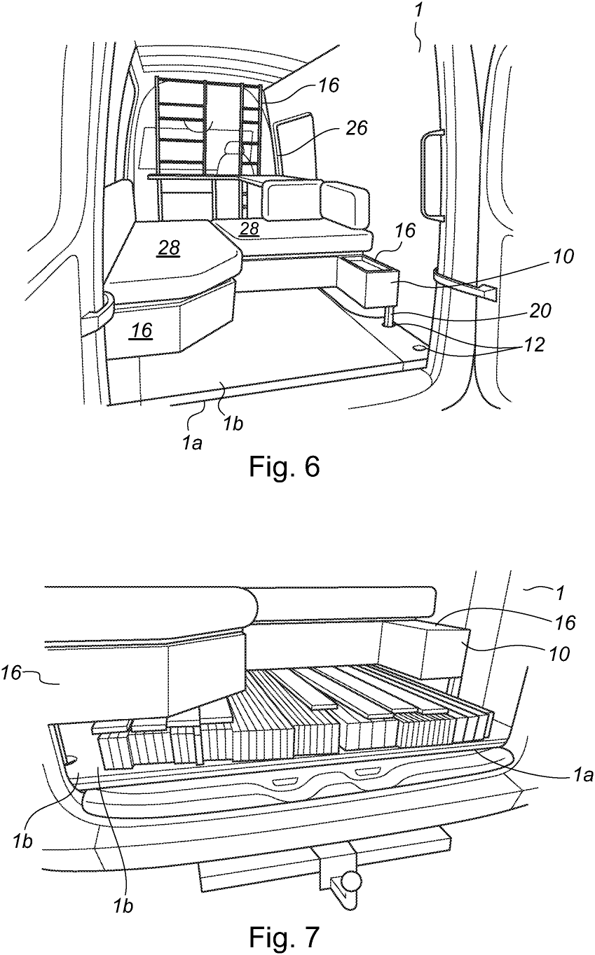

As illustrated in FIGS. 2a, 5 and 6, the frame modules 16 may be attachable in the direction of the longitudinal axis 3, lateral axis 5 and/or vertical axis 7 of the vehicle 1. With reference to FIGS. 5 and 6, a frame module 16 is attached to an upper surface 16b of a lower frame module 16. In this arrangement, the upper frame module 16 is stacked, or arranged vertically, with respect to the lower frame module 16. As described further below the upper frame module 16 may be attached to front portion 1d, or roof 1i, of the vehicle 1. In this arrangement the upper frame module 16 is not attached to the base portion 1a of the vehicle 1.

With reference to FIGS. 2a to 2c, the modular support frame 10 may further comprise frame module support members 22 (one frame module support member being an example of a frame module). The frame module support member 22 may be a frame module 16 of the modular support frame 10.

In the embodiment illustrated and described here, the frame module support members 22 are configured to provide support to two frame modules 16e and 16d that are spaced apart from one another. As illustrated, the frame module support members 22 provide support to each frame module 16. The frame module support members 22 may be brace members, or strut members, that prevent translation, or collapse, of the frame modules 16e and 16d.

The frame module support members 22 are releasably attachable to each frame module 16e, 16d. The frame module support members 22 are attachable to the base portion 1a of the vehicle 1. The method of attachment of the frame module support members 22 to the base portion 1a of the vehicle 1 may be the same as the method of attaching the modular support frame 10 and the frame modules 16 described above. The area of location of the frame module support members 22 to the base portion 1a of the vehicle 1 may also be the same as the method of attaching the modular support frame 10 and the frame modules 16 described above. The frame module support members 22 may be arranged longitudinally, laterally, or vertically between frame modules 16. The frame module support members 22 may be arranged extend longitudinally along the sides 1f, 1g of the vehicle 1.

The frame module support members 22 may traverse the load carrying area 1b of the vehicle 1. The frame module support members 22 may be spaced from the load carrying area 1b of the vehicle 1. The frame module support members 22 may be capable of carrying a load. The frame module support members 22 may be attachable to the frame module attachment member 16c of the frame modules 16d, 16e, 16. Alternatively, the frame module support members 22 may be attachable to the frame modules 16d, 16e, 16 by other suitable releasable fastening devices, such as a nut and bolt, or the like.

As described above, the frame module support member 22 may be an example of one of the at least two frame modules of the present invention. The frame module support member 22 may be an example of a frame module of the modular support frame of the present invention.

In the embodiment illustrated and described here, the frame module support member 22 may be a first frame module and one of the frame modules 16d, 16e, or any other frame module 16, may be second frame module. The frame module support member 22 may be attachable to the vehicle 1 and the other frame module 16d, 16e may be attachable to the frame module support member 22. The other frame module 16d, 16e, 16 may also be attachable to the vehicle 1.

The frame module support members 22 may be configured to provide support to the other frame module(s) 16d, 16e, 16. The other frame module 16d, 16e, 16 may be configured to provide support to an article or object mounted thereon, or thereto.

In this arrangement the frame module support member 22 is directly attached to the vehicle 1 and the other frame module(s) 16d, 16e, 16 is attached to the frame module support member 22. The other frame module 16d, 16e, 16 may also be attached to the vehicle. A frame module support member 22 may be configured to provide support to the at least two frame modules of the present invention. In this arrangement the at least two frame modules 16d, 16e, 16 are not directly attached to the vehicle 1. In this arrangement the at least two frame modules 16d, 16e, 16 are indirectly attached to the vehicle 1 via the frame module support member(s) 22.

It should be appreciated that each frame module support member 22 may be a frame module of the modular support frame of the present invention.

FIG. 1c illustrates alternative attachment points 12′ of the vehicle 1 for the modular support frame 10. In the embodiment illustrated and described here, the attachment points 12′ are located on the side portions 1f and 1g of the vehicle 1. In this arrangement the modular support frame 10 is supported by the side portions 1f and 1g of the vehicle 1, as opposed to the base portion 1a.

The attachment points 12′ may be similar to the attachment points 12 of FIGS. 1a and 1b, in that they may be configured to receive a threaded member such as a threaded bolt and nut. However, it may be the case that attachment points 12′ may need to be created on the vehicle 1 prior to installation of the modular support frame 10. In this arrangement attachment points 12′, such as brackets, or the like, may need to be fixed by, for example, welding, bolting, riveting, adhesive bonding, magnetic attraction to the vehicle 1.

The attachment points 12′ are again configured receive and engage with corresponding vehicle attachment members 18 of the modular support frame 10. The attachment points 12′ are arranged to lie on the same plane. In alternative configurations, the attachment points 12′ may be arranged to lie in different planes to suite the configuration of the modular support frame 10, or vehicle 1. The location of the vehicle attachment members 18 of the modular support frame 10 are arranged to align with the location of the one or more attachment points 12′ on the vehicle 1.

Again, the attachment points 12′ are located outside the load carrying area 1b of the vehicle 1. In this arrangement, the modular support member 10 is suspended above the base portion 1a of the vehicle 1. It therefore follows that the load carrying area 1b of the vehicle 1 is accessible, as the modular support frame 10 is located above the load carrying area 1b.

As illustrated in FIG. 1c, each attachment point 12′ may be associated with a lower support attachment point 12b. The lower support attachment point 12 may be attached to the side portions 1f, 1g of the vehicle 1. Between each attachment point 12′ and the lower support attachment point 12b there may be provide a support member 12c, such as a strut member or brace member. The lower support attachment point 12b and support member 12c may provide additional support to the side portions 1f, 1g of the vehicle 1 to support the modular support frame 10. Support members 12c may also allow the attachment of the frame 10 to the vehicle 1.

It should be appreciated that each frame module 16 of the modular support frame 10 may be releasably attachable to the attachment points 12′ of the vehicle 1. That is, each frame module 16 may be attachable separately/independently to the attachment points 12′ of the vehicle 1. The attachment points 12′ are again configured receive and engage with corresponding vehicle attachment members 18 of the frame modules 16. The location of the vehicle attachment members 18 of the frame modules 16 are arranged to align with the location of the one or more attachment points 12′ on the vehicle 1.

Again, the attachment points 12′ are located outside the load carrying area 1b of the vehicle 1. In this arrangement, the modular support member 10 is suspended above the base portion 1a of the vehicle 1. It therefore follows that the load carrying area 1b of the vehicle 1 is accessible, as the modular support frame 10 is located above the load carrying area 1b.

When the modular frame 10 is mounted to the side portions 1f, 1g of the vehicle, it should be appreciated that it may not include the support legs 20. In this arrangement, the vehicle attachment points 18 of the modular support frame 10 may be located on side portions 10c thereof, as illustrated in FIG. 2a.

FIG. 2d is an alternative illustration of the modular support frame 10′ of FIG. 2a. As illustrated and described above, the modular support frame 10 of FIG. 2a includes a plurality of frame modules 16, each frame module being attachable to the base portion 1a, or side portions 1f, 1g, of the vehicle 1.

However, in the alternative arrangement, the modular support frame 10′ may include a frame module support member 24 that is attachable to the base portion 1a, or side portions 1f, 1g, of the vehicle 1, and to which each frame module 16 may be attached. Each frame module 16 is attached to the frame module support member 24 at points B. The dashed lines at points B in FIG. 2d illustrate where each frame module may be separated from the frame module support member 24. The arrows in FIG. 2d illustrate the direction in which the frame modules 16 and frame module support members 24 may be separated. This arrangement is an example of a modular support frame in accordance with the present invention. A frame module support member 24 is also an example of a frame module in accordance with the present invention. A frame module support member 24 is also an example of one of the at least two frame modules in accordance with the present invention. A frame module support member 24 may be a first frame module and the other of the at least two frame modules 16 may be a second frame module. The frame module support member 24 may be attachable to the vehicle 1 and the other frame module 16 may be attachable to the frame module support member 24. The frame module support member 24 may be configured to provide support to the other frame module 16. As described further below, the other frame module 16 may be configured to provide support to an article or object mounted thereon, or thereto.

The frame module support members 24 are structural support members constructed from a plurality of structural members 24a. Each structural member 24a is an elongate member. The structural members 24a may be attached together (fixedly, or releasably) to form the frame module support members 24.

In the embodiment illustrated and described here, the modular support frame 10′ includes three frame module support members 24. Two of the frame module support members 24 are located at either side portion 1f and 1g of the vehicle 1, and the third frame module support member 24 is located at the front portion 1d of the vehicle. The frame module support members 24 may be releasably attachable to one another, or fixedly attached to one another. Each frame module support member 24 may be a frame module of the modular support frame 10′.

The frame module support members 24 are configured such that they can be installed within the vehicle 1. Again, the frame module support members 24 are removably attachable to the vehicle 1. This allows the modular support frame 10′ to be temporarily used with the vehicle 1. Alternatively, the frame module support members 24 may be fixedly attached to the vehicle 1.

With reference to FIGS. 2d and 3, the frame module support members 24 are attachable to the base portion 1a, or side portions 1f, 1g, of the vehicle 1. The frame module support members 24 are attached to the vehicle 1 at attachment points 12. The frame module support members 24 include a plurality of vehicle attachment members 18. The vehicle attachment members 18 are configured to be releasably engageable with the attachment points 12 of the base portion 1a of the vehicle 1. The vehicle attachment members 18 are arranged to align with the attachment points 12 of the base portion 1a of the vehicle 1.

In the embodiment illustrated and described here, the frame module support members 24 include a plurality of support legs 20 attached to a lower surface 24b thereof, and the vehicle attachment members 18 are located at lower portions 20a of each support leg 20. However, it should be appreciated that the frame module support members 24 may not include support legs 20, and that the vehicle attachment members 18 may be on the lower surface 24b of the frame module support members 24.

Again, the support legs 20 are configured to provide support to the frame module support members 24. The support legs 20 are also configured to space the frame module support members 24/modular support frame 10′ from the base portion 1 a/load carrying area 1b. That is, the support legs 20 raise the modular support frame 10′ from the base portion 1a/load carrying area 1b. As described further below, in this arrangement the load carrying area 1b of the vehicle 1 is accessible, as the modular support frame 10′ is located above the load carrying area 1b and provides access to the load carrying area 1b.

The attachment of the frame module support members 24 to the vehicle 1 is the same as that described above in relation to the modular support frame 10. This includes attachment of the frame module support members 24 to the side portions 1f, 1g of the vehicle 1. The modular support frame 10′ is spaced from the base portion 1a of the vehicle 1.

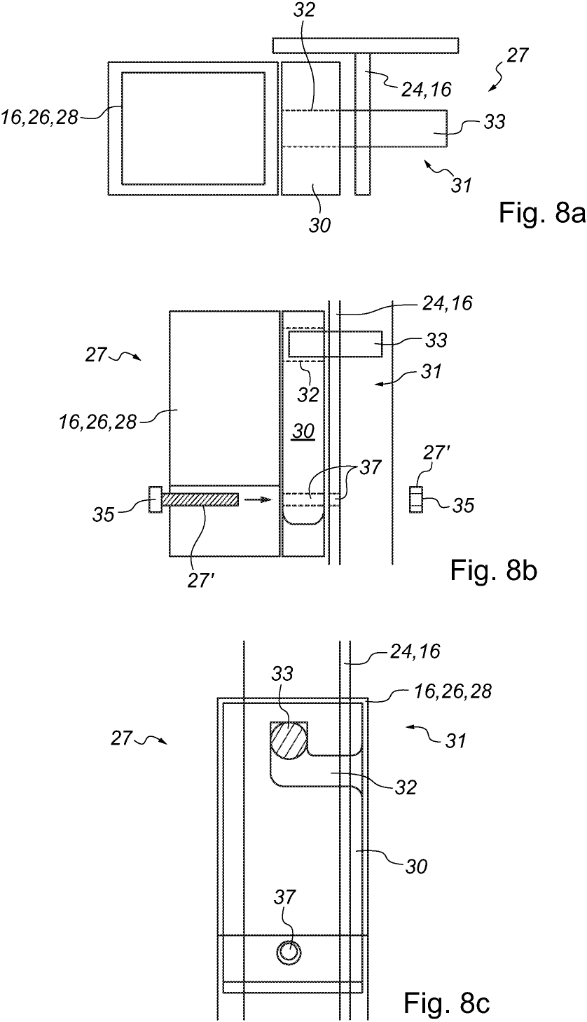

In this embodiment, each frame module 16 is attached to a frame module support member 24. An example of a frame module attachment member 27 is illustrated in FIGS. 8a to 8c. FIGS. 8a, 8b and 8c are top, front and side views of the frame module attachment member 27, respectively.

In this embodiment it should be appreciated that the, or each, frame module support member 24 may be installed in the vehicle, as described above, and each frame module 16 may be attached to the frame 24. Again, each frame module 16 may be attached and reattached as required by the user. It should be appreciated that the modular support frame 10′ in this configuration allows the frame modules 16 to be removed from the vehicle 1 if the vehicle 1 is to be used for an alternative purpose, but the frame module support member(s) 24 may remain in the vehicle 1. The user can then quickly reattach the frame modules 16 to convert the vehicle 1 back to its original purpose, or another purpose, due to the interchangeability of the frame modules 16.

As illustrated in FIGS. 8a to 8c, the frame module attachment member 27 includes a bracket 30 and engaging member 31. The bracket 30 is configured to be attachable to a frame module 16 and the engaging member 31 is located on the frame module support member 24. The engaging member 31 includes a pin member 33. The pin member 33 may be removably attachable to the frame module support member 24. The bracket 30 includes a pin member receiving slot 32, which is configured to receive and engage with the pin member 33. The frame module 16 is attached to the frame module support member 24 by mounting the bracket 30 to the pin member 33. The pin member 33 (and frame module support member 24) thus provide support to the frame module 16. The frame module attachment member 27 may further comprise a releasable fastening device 27′, which includes a nut and bolt 35, which is configured to engage with a holes 37 in the frame module support member 24 and the bracket 30.

The frame module attachment member 27 allows the frame module 16 to be releasably attachable to the frame module support member 24.

It should also be appreciated that the frame module attachment members may be threaded bolts and nuts (an example of a releasable fastening member). However, it should be appreciated that other suitable fastening devices may be used.

Again, it should be appreciated that each frame module 16 may be releasably attachable to another frame module 16 at more than one location.

In this arrangement, each frame module 16 is spaced from the base portion 1a of the vehicle 1. In this arrangement, each frame module 16 is attached to the frame module support members 24, and is suspended above the base portion 1a of the vehicle 1. In this arrangement the frame module support member 24 is directly attached to the vehicle 1 and the other frame module 16 is not directly attached to the vehicle 1.

Again, with each frame module 16 being removably attachable to the vehicle 1, this allows the configuration of the modular support frame 10′ to be altered to suit the requirements of the user of the vehicle 1. The frame modules 16 of the modular support frame 10′ may be interchangeable. The frame modules 16 of the modular support frame 10′ may be repositioned at more than one location. Thus, the configuration of the frame modules 16 may be varied by altering the position of any frame module 16.

With reference to FIGS. 5 to 7, each frame module 16 (and frame module support member) may be configured to support an article, or object, above the base portion 1a of the vehicle 1. Similarly, each frame module 16 may be configured to receive an article, or object, therein, or thereon. Each frame module 16 may be a storage module.

Each frame module 16 may have a length (L), width (W) and height (H). The lengths (L), widths (W) and heights (H) of the frame modules 16 may be integer multiples. That is, the length (L) of the frame modules 16 may be 2×L, 3×L, 4×L, etc. The width (W) of the frame modules 16 may be 2×W, 3×W, 4×W, etc. The height (H) of the frame modules 16 may be 2×H, 3×H, 4×H, etc. The frame modules 16 may be double, triple, quadruple etc. length, width, or height. This standardising of the dimensions of the frame modules 16 simplifies construction and assembly of the modular support frame 10, 10′ and allows flexibility with the mounting location of each frame module, e.g., sink location, refrigerator, seat, table etc.

In the embodiment illustrated and described here, each frame module 16 is configured to support a domestic, or retail, appliance, home appliance, household appliance, or retail appliance 26. Such a domestic, or retail, appliance, home appliance, or household appliance may include an oven, a stove, a cooking device, a dishwasher, a clothes dryer, a washing machine, a waste disposal unit, a refrigerator, a freezer, a microwave, an air conditioning unit, a water heater, a trash/waste compactor, an induction cooker, an electric mixer, coffee grinder, coffee machine, a medical device, an emergency response device, or the like. Similarly, each frame module 16 may be configured to support an entertainment and information appliance, Such an entertainment and information appliance may include a home electronics device, a radio receiver, a television set, a music stereo system, a personal computer, a mobile telecommunication device, a medical device, an emergency response device, a navigation device, a data gathering device, a camera, a GPS device, or the like. Also, each frame module 16 may be configured to support an amenity, such as a domestic, or retail, amenity 28. Such an amenity may include a shower, sofa, sofa bed, a bed, a bath, a worktop, a couch, a chair, a table, a sink, a storage unit, a cupboard, a cabinet, a shelf, a drawer, a drying box, a desk, a heating device, a table, or the like.

The frame module attachment member 27 illustrated in FIGS. 8a to 8c above may also be used to attach the articles, or objects, (26, 28) to the each frame module 16. In this arrangement, the engaging member 31 is located on the frame module 16 and the bracket 30 is located on the article, or object, (26, 28). However, it should be appreciated that other arrangements are possible. Similarly, it should be appreciated that other releasable fastening devices may be used. The frame module attachment member 27 is advantageous in that it allows simple and quick installation of the article or object in the frame module 16 and/or the frame module 16 to the frame module support member 24. The article or object may be slotted/hooked to the frame module 16 and the frame module may be slotted/hooked to the frame module support member 24.

Each frame module 16 may be configured to receive a supply of electricity, and may include one or more electrical power supply sockets.

The one or more articles, amenities or appliances may be objects required for the function of the environment within the vehicle 1. That is, the articles, amenities and appliances may be relevant for the living/working environment intended within the vehicle 1.

As described above, the modular support frame 10, 10′ is installed in the vehicle 1 either on the base portion 1a, or on the side portions 1f, 1g. (It should be appreciated that the modular support frame 10, 10′ may also be installed in the vehicle 1 on the front and/or rear portions 1d, 1e. The modular support frame 10, 10′ is attached to the vehicle 1 by attachment points 12, 12′ and the vehicle attachment members 18. The modular support frame 10, 10′ is thus releasably attachable to the vehicle 1. The installation of the modular support frame 10, 10′ in the vehicle 1 is illustrated inf FIGS. 3 to 7. FIGS. 3 to 4b illustrate the installation of the modular support frame 10, 10′ on the base portion 1a of the vehicle 1. (FIG. 1c illustrates the attachment points 12′ for the attachment of the modular support frame 10, 10′ to the side portions 1f, 1g of the vehicle 1). FIGS. 5 and 6 illustrates the modular support frame 10, 10′ with appliances/amenities 26, 28 mounted to the frame modules 16 (dishwasher, sink, storage unit, seating area/couch). FIG. 6 also illustrates the modular support frame 10, 10′ being raised from the base portion 1a of the vehicle 1. FIG. 7 illustrates how the load carrying area 1b of the vehicle 1 remains accessible when the modular support frame 10, 10′ is installed in the vehicle 1. The modular support frame 10, 10′ may be substantially parallel to the base portion 1a/load carrying area 1b of the vehicle 1.

The modular support frame 10, 10′ of the present invention allows the frame modules 16 (and appliances) to be interchanged, swapped, changed etc. This allows the modular support frame 10, 10′ to be configured (re-configured) to suit the use of the user of the vehicle 1. Thus, depending on the required use of the vehicle 1 for a particular task, the user may reconfigure the frame accordingly. The frame may then be returned to its original configuration. Providing a plurality of frame modules 16, with each module 16 being configured to support an article, or object, described above, allows a user to customise their vehicle 1, and upgrade, replace or change appliances over time.

Furthermore, as the modular support frame 10, 10′ is raised from the base portion 1a of the vehicle 1, the load carrying area 1b remains accessible. This allows articles or objects to be carried in the vehicle 1 without removing the frame. This provides additional storage within the vehicle 1 underneath the modular support frame 10, 10′. The raised modular support frame10, 10′ may allow for the installation of a further floor, or base portion, in the vehicle 1. The raised modular support frame 10, 10′ may allow for the installation of an underfloor heating module within the vehicle 1. The raised modular support frame 10, 10′ may allow for an increased volume of air above an underfloor heating module so as to improve the flow of hot air within the vehicle 1.

Furthermore, the raised modular support frame 10, 10′ may allow for enhanced aesthetic qualities of the interior of the vehicle 1. The raised modular support frame 10, 10′ may create the impression of an increased space and/or volume within the vehicle 1. The raised modular support frame may create the visible impression of an increased space and/or volume within the vehicle 1.

Modifications may be made to the foregoing embodiment without departing from the scope of the present invention. For example, although the modular support frame 10, 10′ has been illustrated and described above as being raised from the base portion 1a of the vehicle 1, it should be appreciated that the modular support frame 10, 10′ may be located on the base portion 1a, or floor portion, of the vehicle 1.

Furthermore, it should be appreciated that the modular support frame 10, 10′ and each frame module 16 may have a front portion, a rear portion and two side portions, and that the vehicle attachment members 18 may be located on the front portion, rear portion, or side portions thereof. The one or more vehicle attachment members 18 may be located on the at least one, or each, side portion of the modular support frame 10, 10′/frame module 16. The vehicle attachment members 18, may be located on the perimeter of the modular support frame 10, 10′/frame module 16. The vehicle attachment members 18, may be located on the outer edges of the modular support frame 10 10′/frame module 16

Also, it should be appreciated that the modular support frame 10, 10′/frame module 16 may be attached to the vehicle 1 by an adhesive, or the like.

Furthermore, although the modular support frame 10, 10′ has been illustrated and described above as being assembled from a plurality of releasable structural members, it should be appreciated that the modular support frame 10, 10′ may be integrally formed. Similarly, the frame modules 16 may be integrally formed with the other components of the frame, such that the support frame may be a one-piece member. In this arrangement the support frame is an example of a support frame for a vehicle in accordance with the present invention.

Also, although the modular support frame 10 has been illustrated and described above as being attachable to attachment points 12, 12′ of the vehicle 1, it should be appreciated that the modular support frame 10 may be attached directly to the vehicle body, chassis etc., or any other existing part of the structure, including any wall panels.

1. A modular support frame for a vehicle comprising:
at least two frame modules,
wherein the at least two frame modules are configured to be attachable to one another at more than one location.

2. The modular support frame of claim 1, wherein the modular support frame is configured to be attachable to a base portion, floor portion, or load carrying area of the vehicle.

3. The modular support frame of claim 2, wherein the modular support frame is configured to be attachable to: at least one area, or space, between a side portion/wall member and the load carrying area of the vehicle; each area, or space, between the side portions/wall members of the vehicle and the load carrying area of the vehicle; or each area, or space, between the side portions/wall members of the vehicle, at least one area, or space, between a front portion of the vehicle and the load carrying area of the vehicle.

4. The modular support frame of claim 2, wherein the modular support frame is configured to be attachable to one or more side portions/wall members of the vehicle.

5. The modular support frame of claim 2, wherein the modular support frame is configured to be attachable to the vehicle such that it is spaced from a base portion, floor portion, or load carrying area of the vehicle.

6. The modular support frame of claim 1, wherein the modular support frame is configured to be attachable to one or more attachment points on the vehicle.

7. The modular support frame of claim 6, wherein the one or more attachment points of the vehicle are located: on the base portion, floor portion, or load carrying area of the vehicle; outside the load carrying area of the vehicle; in an area, or space, between a side portion/wall member of the vehicle and the load carrying area of the vehicle; in an area, or space, between each side portion/wall member of the vehicle and the load carrying area of the vehicle; in an area, or space, between the front portion of the vehicle and the load carrying area of the vehicle; in an area, or space, between the rear portion of the vehicle and the load carrying area of the vehicle; or in an area, or space, between each side portion/wall member of the vehicle and the load carrying area of the vehicle, and an area, or space, between the front portion of the vehicle and the load carrying area of the vehicle.

8. The modular support frame of claim 6, wherein the one or more attachment points of the vehicle are located on at least one, or both, of the side portions/wall members of the vehicle.

9. (canceled)

10. The modular support frame of claim 6, wherein the modular support frame includes one or more vehicle attachment members, the one or more vehicle attachment members being configured to be releasably engageable with the one or more attachment points of the vehicle.

11. The modular support frame of claim 10, wherein the one or more vehicle attachment members are located on at least one of the front portion, rear portion, side portion(s), upper portion, or lower portion of the modular support frame,
wherein the modular support frame is configured such that the location of the vehicle attachment members on the modular support frame are arranged to align with the location of the one or more attachment points on the vehicle.

12. The modular support frame of claim 1, wherein the modular support frame further comprises one or more support legs, or leg members, the one or more support legs, or leg members, being configured to provide support to the modular support frame when the modular support frame is attached to the base portion, floor portion, or load carrying area of the vehicle.

13. The modular support frame of claim 12, wherein the modular support frame includes one or more vehicle attachment members, the one or more vehicle attachment members being configured to be releasably engageable with the one or more attachment points of the vehicle,
wherein the one or more vehicle attachment members are located on the one or more support legs, or leg members.

14. The modular support frame of claim 13, wherein the vehicle attachment members of the modular support frame include releasable fastening devices, such that the modular support frame may be releasably attachable to the vehicle.

15. (canceled)

16. The modular support frame of claim 14, wherein at least one of the at least two frame modules of the modular support frame includes one or more vehicle attachment members, and the one or more support legs, or leg members.

17. (canceled)

18. (canceled)

19. The modular support frame of claim 1, wherein the modular support frame may include a plurality of frame modules, each frame module being configured to be attachable to one another at more than one location.

20. The modular support frame of claim 1, wherein at least one of the at least two frame modules is configured to provide support to an article or object mounted thereon, or thereto.

21. The modular support frame of claim 20, wherein the modular support frame and/or the at least two frame modules includes one or more article, or object, attachment members, the one or more article, or object, attachment members being configured to releasably engage with the article, or object.

22. The modular support frame claim 1, wherein at least one of the at least two frame modules has a length (L), width (W) and height (H), and the length (L), width (W) and height (H) of each frame module is an integer multiple.

23. (canceled)

24. A modular support frame for a vehicle comprising:
one or more frame modules; and
a frame module support member,
wherein the frame module support member is attachable to the vehicle and is configured to provide support to the one or more frame modules.

25-29. (canceled)

30. A method of installing a modular support frame to a vehicle, the method comprising the steps of:
providing a modular support frame for a vehicle comprising:
at least two frame modules,
wherein the at least two frame modules are configured to be attachable to one another at more than one location;
positioning a first frame module at a first location within the vehicle;
aligning one or more vehicle attachment points of the first frame module with one or more modular support frame attachment points of the vehicle;
attaching the first frame module to the vehicle;
positioning a second frame module at a second location within the vehicle;
aligning one or more vehicle attachment points of the second frame module with one or more modular support frame attachment points of the vehicle;
attaching the second frame module to the vehicle; and
attaching the first and second frame modules together.

31. (canceled)
